(19) United States
(12) Patent Application Publication
(10) Pub. No.: US 2025/0348850 A1
(43) Pub. Date: Nov. 13, 2025

(54) Scheduling System Maintenance Operations In A Cloud Environment

(71) Applicant: Oracle International Corporation, Redwood Shores, CA (US)

(72) Inventors: Bakhtiyar Uddin, Austin, TX (US); Richard Thurston, Snoqualmie, WA (US); Nilkund Aseef, Bothell, WA (US); Tony Long, Edmonds, WA (US); Mohammad Ahmed Memon, Bothell, WA (US)

(73) Assignee: Oracle International Corporation, Redwood Shores, CA (US)

(21) Appl. No.: 18/813,182

(22) Filed: Aug. 23, 2024

Related U.S. Application Data
(60) Provisional application No. 63/644,117, filed on May 8, 2024.

(51) Int. Cl. G06Q 10/20; G06Q 10/1093

(52) U.S. Cl. CPC G06Q 10/20; G06Q 10/1097

(57) ABSTRACT

Techniques for scheduling system maintenance operations in a cloud environment are disclosed. A system receives a first request to execute a first system maintenance operation within a first time period. The system selects a first plurality of candidate execution times within the first time period for execution of the first system maintenance operation. The system executes a hash function on a first attribute associated with the first request to select a first execution time within the first plurality of candidate execution times. The system schedules the execution of the first system maintenance operation at the first execution time.

### INCORPORATION BY REFERENCE; DISCLAIMER

The following application is hereby incorporated by reference: application No. 63/644,117 filed on May 8, 2024. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to cloud environments. More particularly, the present disclosure relates to systems and methods for scheduling system maintenance operations in cloud environments.

### BACKGROUND

A cloud computing environment can be used to provide access to a range of complementary cloud-based components, such as software applications or services, that enable organizations or enterprise customers to operate their applications and services in a highly available hosted environment. The benefits to an organization in moving their application and service needs to a cloud environment include reductions in the cost and complexity of designing, building, operating, and maintaining their own on-premise data center, software application framework, or other information technology infrastructure.

System maintenance is performed on cloud computing environments from time to time. The system maintenance may encompass a wide range of operations aimed at ensuring the availability, performance, and security of the cloud environment. As examples, the system maintenance may include several operations, such as updating software components, applying security patches, and performing hardware upgrades across various portions of the cloud environment.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system for providing a cloud infrastructure environment in accordance with an embodiment.

FIG. 2 further illustrates how a cloud infrastructure environment can be used to provide cloud-based applications or services or services in accordance with an embodiment.

FIG. 3 illustrates an example cloud infrastructure architecture in accordance with an embodiment.

FIG. 4 illustrates another example of a cloud infrastructure architecture in accordance with an embodiment.

FIG. 5 illustrates another example of a cloud infrastructure architecture in accordance with an embodiment.

FIG. 6 illustrates another example of a cloud infrastructure architecture in accordance with an embodiment.

FIG. 7 illustrates how the system can provide dedicated or private label cloud environments for use by tenants or customers of a cloud infrastructure environment in accordance with an embodiment.

FIG. 8 further illustrates the use of private label cloud realms for use by tenants or customers of a cloud infrastructure environment in accordance with an embodiment.

FIG. 9 further illustrates the use of private label cloud realms for use by tenants or customers of a cloud infrastructure environment in accordance with an embodiment.

FIG. 10 illustrates a system for providing access to software products or services in a cloud computing or other computing environment in accordance with an embodiment.

FIGS. 11A and 11B illustrate an example system for scheduling system maintenance operations in accordance with one or more embodiments.

FIGS. 12A and 12B illustrate example operations for scheduling system maintenance operations in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. EXAMPLE CLOUD ENVIRONMENTS
3. SYSTEM ARCHITECTURE FOR SCHEDULING SYSTEM MAINTENANCE OPERATIONS IN A CLOUD ENVIRONMENT
4. EXAMPLE OPERATIONS FOR SCHEDULING SYSTEM MAINTENANCE
5. MISCELLANEOUS; EXTENSIONS

### 1. General Overview

One or more embodiments determine a time for performing a system maintenance operation by executing a hash function on an attribute associated with the target of the system maintenance operation. The use of a hash function for selecting execution times may result in system maintenance operations with similar or identical attributes being scheduled at similar times (e.g., a same time of day or same day of week). Furthermore, the use of a hash function for selecting execution times may result in system maintenance operations with different attributes being semi-randomly distributed across available times.

In one example, a system performs a system maintenance operation on a resource of a cloud environment. The target of the system maintenance is the resource, and the attribute associated with the maintenance is a resource identifier. The resources may be utilized by customers of a cloud operator that maintains the cloud environment. The customers may select a time period when they prefer the cloud operator to perform system maintenance on the particular resources utilized by particular customers. A set of customers may select a particular time period, and the execution times for particular customers may be distributed across the particular time period. To distribute the execution times across the particular time period, the cloud operator executes the hash function on the attributes respectively associated with the set of customers to obtain a semi-random set of execution times within the particular time period. Thus, utilization of resources for performing the system maintenance is distributed semi-randomly across the particular time period, thereby avoiding resource constraints or spikes in resource utilization that might otherwise arise if too many customers selected the same time for performing system maintenance. Accordingly, customers are given some choice over when system maintenance is performed while also avoiding resource constraints or spikes in resource utilization.

In one example, the system allows system maintenance operations to be scheduled at a consistent time for various customers within time windows specified by the customers, for example, in service level agreements (SLAs), while also distributing the execution times for the system maintenance operations semi-randomly to avoid resource constraints or spikes in resource utilization while performing the system maintenance operations. Accordingly, the system helps to maintain the stability and reliability of the cloud environment by keeping resources up to date on system maintenance.

One or more embodiments described in this Specification and/or recited in the claims may not be included in this General Overview section.

### 2. Example Cloud Environments

One or more embodiments provide features associated with cloud environments, including PLC environments. The cloud environments can be utilized, for example, by customers or tenants of a cloud infrastructure provider or reseller, in accessing software products, services, or other cloud offerings.

A cloud computing or cloud infrastructure environment can be used to provide access to a range of complementary cloud-based components, such as software applications or services, that enable organizations or enterprise customers to operate their applications and services in a highly available hosted environment. The benefits to an organization in moving their application and service needs to a cloud infrastructure environment include a reduction in the cost and complexity of designing, building, operating, and maintaining their own on-premise data center, software application framework, or other information technology infrastructure. Organizations that utilize a cloud environment may utilize various operational tools to monitor the operations and performance of the cloud environment.

### Cloud Infrastructure Environments

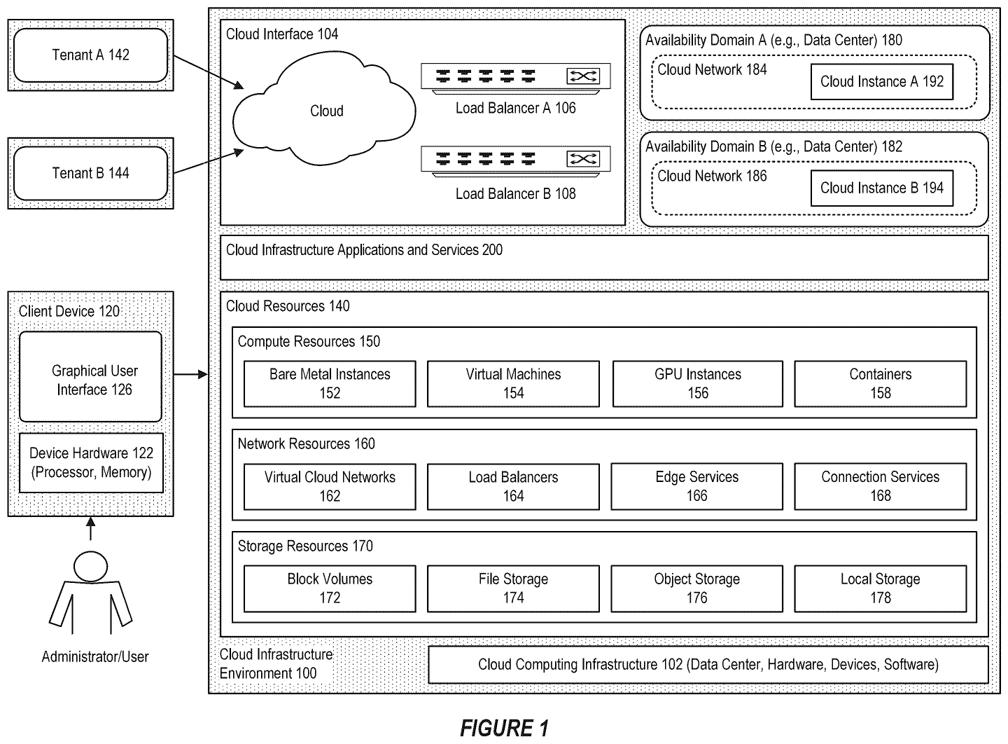

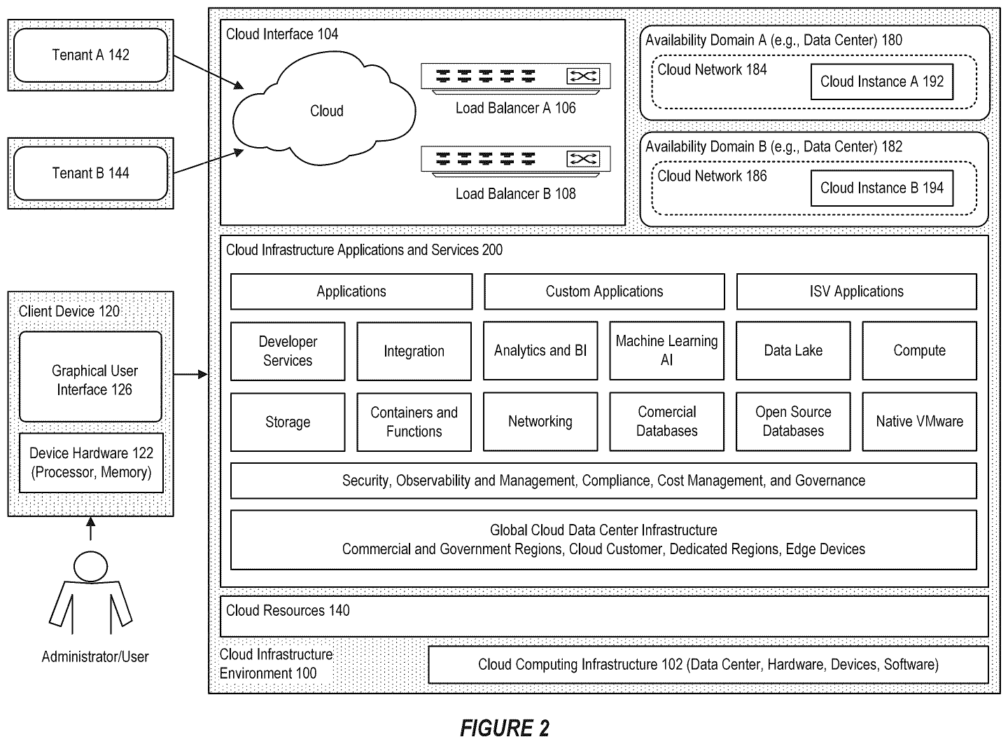

FIGS. 1 and 2 illustrate a system for providing a cloud infrastructure environment in accordance with an embodiment.

In accordance with an embodiment, the components and processes illustrated in FIG. 1, and as further described herein regarding various embodiments, can be provided as software or program code executable by a computer system or other type of processing device, for example, a cloud computing system.

The illustrated example is provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

As illustrated in FIG. 1, in accordance with an embodiment, a cloud infrastructure environment 100 can operate on a cloud computing infrastructure 102 comprising hardware (e.g., processor, memory), software resources, and one or more cloud interfaces 104 or other application program interfaces (API) that provide access to the shared cloud resources via one or more load balancers A 106, B 108. Cloud interface 102 includes user interfaces and APIs provided by a cloud services provider for interacting with its cloud services. This includes tools and platforms that allow users and administrators to manage, configure, and monitor cloud resources and services. Cloud interface 102 may include a console, such as a web-based user interface that provides a visual way to interact with and manage cloud resources. Through the console, users may, for example, create, configure, and monitor cloud services like compute instances, databases, storage, and networking components. Cloud interface 102 may also include a command line interface for users who prefer to work with the cloud infrastructure using command-line tools. The CLI allows for scripting and automation of cloud management tasks in an embodiment.

In accordance with an embodiment, load balancer A 106 and load balancer B 108 are services that distribute incoming network traffic across multiple servers, instances, or other resources to ensure that no single resource bears too much demand. By spreading the requests evenly across the resources, load balancers enhance the responsiveness and availability of resources such as applications, websites, or databases. Load balancer A 106 and load balancer B 108 may be either public load balancers that are accessible from the Internet and used for distributing external traffic, or private load balancers that are used within a virtual cloud network (VCN) and are not accessible from the public Internet (and are therefore ideal for internal traffic distribution). In an embodiment, load balancer A 106 and load balancer B 108 are designed for high availability and fault tolerance and are implemented in a redundant configuration across multiple availability domains or fault domains.

In accordance with an embodiment, the cloud infrastructure environment supports the use of availability domains, such as availability domain A 180 and availability domain B 182, that enable customers to create and access cloud networks 184, 186, and run cloud instances A 192, B 194. In an embodiment, availability A 180 and availability domain B 182 may represent a data center, or a set of data centers located within a region. These availability domains may be isolated from each other, meaning that they may not share the same physical infrastructure such as power or cooling systems. This design provides a high degree of failure independence and robustness. In an embodiment, a fault domain may provide additional protection and resiliency within a single availability domain by grouping hardware and infrastructure within an availability domain that is isolated from other fault domains. This isolation may be in terms of electricity, cooling, and other potential sources of failure.

In accordance with an embodiment, a tenancy (a container for resources used by a tenant) can be created for each cloud tenant/customer, for example, tenant A 142, B 144, that provides a secure and isolated partition within the cloud infrastructure environment where the customer can create, organize, and administer their cloud resources. A cloud tenant/customer can access an availability domain and a cloud network to access each of their cloud instances. A tenancy in is isolated from other tenancies, ensuring that each customer's data and resources are secure and inaccessible to others. Within a tenancy, customers can create, manage, and organize a wide range of cloud resources, including compute instances, storage volumes, and networks. In Identity and Access Management (IAM) service enables the management of users, groups, and policies within a tenancy. Through IAM, customers can control who has access to their resources and what actions they can perform. The tenancy is also the level where billing and subscription management are handled. Usage and costs associated with the resources within a tenancy are tracked and billed collectively under that tenancy. Each tenancy may be associated with specific service limits and quotas for various resources. These limits may be used to help manage capacity and facilitate resource distribution across each tenant.

In accordance with an embodiment, a computing device, such as a client device 120 having a device hardware 122 (e.g., processor, memory) and graphical user interface 126, can enable an administrator or other user to communicate with the cloud infrastructure environment via a network, such as a wide area network, a local area network, or the Internet, to create or update cloud services.

In accordance with an embodiment, the cloud infrastructure environment provides access to shared cloud resources 140 via, for example, a compute resources layer 150, a network resources layer 160, and/or a storage resources layer 170. Customers can launch cloud instances as needed to meet compute and application requirements. After a customer provisions and launches a cloud instance, the provisioned cloud instance can be accessed from a client device such as client device 120.

In accordance with an embodiment, compute resources 150 can comprise resources, such as bare metal cloud instances 152, virtual machines 154, graphical processing unit (GPU) compute cloud instances 156, and/or containers 158. A bare metal instance represents a physical server with dedicated hardware that is fully allocated to a single tenant. A bare metal instance provides direct access to the server's processor, memory, storage, and other hardware resources. A virtual machine (VM) is a software emulation of a physical computer that runs an operating system and applications like a physical computer. VMs allow multiple operating systems to run on a single physical machine or across multiple machines. A hypervisor layer resides between the hardware and the virtual machines, allocating physical resources (like CPU, memory, and storage) to each VM. In an embodiment, GPU compute cloud instances provide GPUs along with traditional CPU resources. These instances are designed for tasks that require significant parallel processing power, making them ideal for applications like machine learning, scientific computing, 3D rendering, and video processing. In an embodiment, Containers 158 use a method of virtualization that allows for the running of multiple isolated applications on a single control host, virtualizing the operating system. Each container shares the host system's kernel but runs in an isolated user space, making containers lightweight and efficient.

The components of the compute resources 150 can be used to provision and manage bare metal compute cloud instances or provision cloud instances as needed to deploy and run applications, as in an on-premises data center. For example, in accordance with an embodiment, the cloud infrastructure environment can provide control of physical host (bare metal) machines within the compute resources layer that run as compute cloud instances directly on bare metal servers without a hypervisor.

In accordance with an embodiment, the cloud infrastructure environment can also provide control of virtual machines within the compute resources layer that can be launched, for example, from an image, wherein the types and quantities of resources available to a virtual machine cloud instance can be determined, for example, based upon the image that the virtual machine was launched from.

In accordance with an embodiment, the network resources layer can comprise several network-related resources, such as virtual cloud networks (VCNs) 162, load balancers 164, edge services 166, and/or connection services 168. In an embodiment, a virtual cloud network (VCN) is a customizable and private network in a cloud environment. A VCN provides a virtual version of a traditional network, including subnets, route tables, and gateways. It allows users to set up their cloud-based network architecture according to their requirements. In an embodiment, edge services 166 include services and technologies designed to bring computation, data storage, and networking capabilities closer to the location where they are needed. Edge services 166 may be used to optimize traffic, reduce latency, or provide other advantages.

In accordance with an embodiment, the storage resources layer can comprise several resources, such as data/block volumes 172, file storage 174, object storage 176, and/or local storage 178. Data/block volumes 172 provide unformatted block-level storage that can be used to create file systems that host databases or for other purposes requiring unformatted storage. File storage 174 provides a file system in an embodiment and may offer shared file systems that multiple instances can access concurrently using standard file storage protocols. Object storage 176 manages data as objects within storage buckets. Objects have certain attributes that may include data, metadata, and a unique identifier. Local storage 178 refers to storage devices that are physically attached to the host computer.

As illustrated in FIG. 2, in accordance with an embodiment, the cloud infrastructure environment can include a range of complementary cloud-based components, such as cloud infrastructure applications and services 200, that enable organizations or enterprise customers to operate their applications and services in a highly available hosted environment.

In accordance with an embodiment, a self-contained cloud region can be provided as a complete, e.g., Oracle Cloud Infrastructure (OCI), dedicated region within an organization's data center that offers the data center operator the agility, scalability, and economics of an e.g., OCI public cloud, while retaining full control of their data and applications to meet security, regulatory, or data residency requirements.

For example, in accordance with an embodiment, such an environment can include racks physically and logically managed by a cloud infrastructure provider (e.g., Oracle), customer's racks, access for cloud operations personnel for setup and hardware support, customer's data center power and cooling, customer's floor space, an area for customer's data center personnel, and a physical access cage.

In accordance with an embodiment, a dedicated region offers to a tenant/customer the same set of infrastructure-as-a-service (IaaS), platform-as-a-service (PaaS), and software-as-a-service (SaaS) products or services available in the cloud infrastructure provider's (e.g., Oracle's) public cloud regions, for example, ERP, Financials, HCM, and SCM. A customer can seamlessly lift and shift legacy workloads using the cloud infrastructure provider's services (e.g., bare metal compute, VMs, and GPUs), database services (e.g., Oracle Autonomous Database), or container-based services (e.g., Oracle Container Engine for Kubernetes).

In accordance with an embodiment, a cloud infrastructure environment can operate according to an infrastructure-as-a-service (IaaS) model that enables the environment to provide virtualized computing resources over a public network (e.g., the Internet)

In an IaaS model, a cloud infrastructure provider can host the infrastructure components (e.g., servers, storage devices, network nodes (e.g., hardware), deployment software, platform virtualization (e.g., a hypervisor layer), or the like). In some cases, a cloud infrastructure provider may also supply a variety of services to accompany those infrastructure components; example services include billing software, monitoring software, logging software, load balancing software, or clustering software. Thus, as these services may be policy-driven, IaaS users may be able to implement policies to drive load balancing to maintain application availability and performance.

In accordance with an embodiment, IaaS customers may access resources and services through a wide area network (WAN), such as the Internet, and can use the cloud infrastructure provider's services to install the remaining elements of an application stack. For example, the user can log in to the IaaS platform to create virtual machines (VMs), install operating systems (OSs) on each VM, deploy middleware such as databases, create storage buckets for workloads and backups, and install enterprise software into that VM. Customers can then use the provider's services to perform various functions, including balancing network traffic, troubleshooting application issues, monitoring performance, or managing disaster recovery.

In accordance with an embodiment, a cloud infrastructure provider may, but need not, be a third-party service that specializes in providing (e.g., offering, renting, selling) IaaS. An entity might also opt to deploy a private cloud, becoming its own provider of infrastructure services.

In accordance with an embodiment, IaaS deployment is the process of putting a new application, or a new version of an application, onto a prepared application server or the like. It may also include the process of preparing the server (e.g., installing libraries or daemons). This is often managed by the cloud infrastructure provider below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like).

In accordance with an embodiment, IaaS provisioning may refer to acquiring computers or virtual hosts for use and installing needed libraries or services on them. In most cases, deployment does not include provisioning, and the provisioning may need to be performed first.

In accordance with an embodiment, challenges for IaaS provisioning include the initial challenge of provisioning the initial set of infrastructure before anything is running. Second, there is the challenge of evolving the existing infrastructure (e.g., adding new services, changing services, or removing services) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on others, and how they each work together) can be described declaratively. In some instances, once the topology is defined, a workflow can be generated that creates and/or manages the different components described in the configuration files.

In accordance with an embodiment, a cloud infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up for one or more virtual machines (VMs). Other infrastructure elements may also be provisioned, such as a load balancer, a database, or the like. As more infrastructure elements are desired and/or added, the infrastructure may incrementally evolve.

In accordance with an embodiment, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various geographic locations). However, in some examples, the infrastructure where the code will be deployed requires provisioning. In some instances, the provisioning can be done manually, a provisioning tool may be utilized to provision the resources, and/or deployment tools may be utilized to deploy the code once the infrastructure is provisioned.

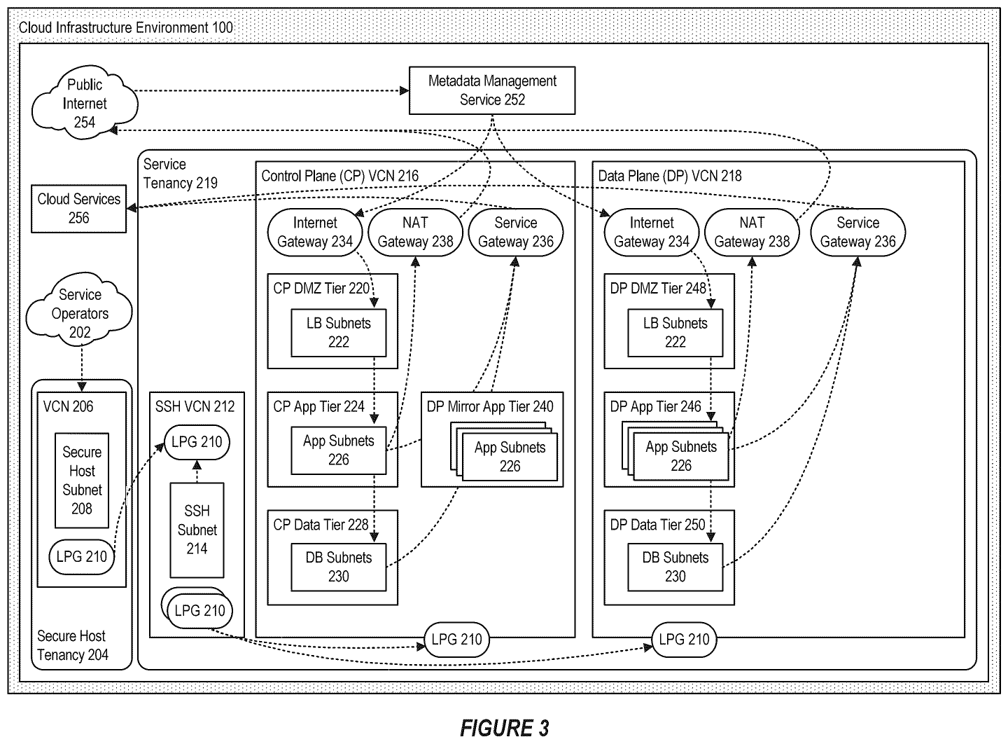

FIG. 3 illustrates an example cloud infrastructure architecture in accordance with an embodiment.

As illustrated in FIG. 3, in accordance with an embodiment, service operators 202 can be communicatively coupled to a secure host tenancy 204 that can include a virtual cloud network (VCN) 206 and a secure host subnet 208.

In some examples, the service operators may be using one or more client computing devices that may be portable handheld devices (e.g., a telephone, a computing tablet, a personal digital assistant (PDA)) or wearable devices (e.g., a head mounted display), running software such as Microsoft Windows, and/or a variety of mobile operating systems, such as iOS, Android, and the like, and being Internet, e-mail, short message service (SMS), or other communication protocol enabled. Alternatively, the client computing devices can be general purpose personal computers including, for example, personal computers and/or laptop computers running various versions of Microsoft Windows®, Apple Macintosh®, and/or Linux operating systems. The client computing devices can be workstation computers running any of a variety of commercially available UNIX® or UNIX-like operating systems, including without limitation the variety of GNU/Linux operating systems such as Chrome OS. Additionally, or alternatively, client computing devices may be any other electronic device, such as a thin-client computer, an Internet-enabled gaming system (e.g., a Microsoft Xbox gaming console), and/or a personal messaging device, capable of communicating over a network that can access the VCN and/or the Internet.

In accordance with an embodiment, a VCN can include a local peering gateway (LPG) 210 that can be communicatively coupled to a secure shell (SSH) VCN 212 via an LPG contained in the SSH VCN. The SSH VCN can include an SSH subnet 214, and the SSH VCN can be communicatively coupled to a control plane VCN 216 via the LPG contained in the control plane VCN. Also, the SSH VCN can be communicatively coupled to a data plane VCN 218 via an LPG. The control plane VCN and the data plane VCN can be contained in a service tenancy 219 that can be owned and/or operated by the cloud infrastructure provider.

In accordance with an embodiment, a control plane VCN can include a control plane demilitarized zone (DMZ) tier 220 that acts as a perimeter network (e.g., portions of a corporate network between the corporate intranet and external networks). The DMZ-based servers may have restricted responsibilities that help contain potential breaches. Additionally, the DMZ tier can include one or more load balancer (LB) subnets 222, a control plane app tier 224 that can include app subnets 226, and a control plane data tier 228 that can include database (DB) subnets 230 (e.g., frontend DB subnet(s) and/or backend DB subnet(s)). The LB subnet(s) contained in the control plane DMZ tier can be communicatively coupled to the app subnet(s) contained in the control plane app tier and to an Internet gateway 234 that can be contained in the control plane VCN. The app subnet(s) can be communicatively coupled to the DB subnet(s) contained in the control plane data tier, a service gateway 236, and a network address translation (NAT) gateway 238. The control plane VCN can include the service gateway and the NAT gateway.

In accordance with an embodiment, the control plane VCN can include a data plane mirror app tier 240 that can include app subnet(s). The app subnet(s) contained in the data plane mirror app tier can include a virtual network interface controller (VNIC) that can execute a compute instance. The compute instance can communicatively couple the app subnet(s) of the data plane mirror app tier to app subnet(s) that can be contained in a data plane app tier.

In accordance with an embodiment, the data plane VCN can include the data plane app tier, a data plane DMZ tier, and a data plane data tier. The data plane DMZ tier can include LB subnet(s) that can be communicatively coupled to the app subnet(s) of the data plane app tier and the Internet gateway of the data plane VCN. The app subnet(s) can be communicatively coupled to the service gateway of the data plane VCN and the NAT gateway of the data plane VCN. The data plane data tier can also include the DB subnet(s) that can be communicatively coupled to the app subnet(s) of the data plane app tier.

In accordance with an embodiment, the Internet gateway of the control plane VCN and of the data plane VCN can be communicatively coupled to a metadata management service 252 that can be communicatively coupled to the public Internet 254. The public Internet can be communicatively coupled to the NAT gateway of the control plane VCN and of the data plane VCN. The service gateway of the control plane VCN and of the data plane VCN can be communicatively coupled to cloud services 256.

In accordance with an embodiment, the service gateway of the control plane VCN, or of the data plane VCN, can make application programming interface (API) calls to cloud services without going through the public Internet. The API calls to cloud services from the service gateway can be one-way; the service gateway can make API calls to cloud services, and cloud services can send requested data to the service gateway. Generally, cloud services may not initiate API calls to the service gateway.

In accordance with an embodiment, the secure host tenancy can be directly connected to the service tenancy that may be otherwise isolated. The secure host subnet can communicate with the SSH subnet through an LPG that may enable two-way communication over an otherwise isolated system. Connecting the secure host subnet to the SSH subnet may give the secure host subnet access to other entities within the service tenancy.

In accordance with an embodiment, the control plane VCN may allow users of the service tenancy to set up or otherwise provision desired resources. Desired resources provisioned in the control plane VCN may be deployed or otherwise used in the data plane VCN. In some examples, the control plane VCN can be isolated from the data plane VCN, and the data plane mirror app tier of the control plane VCN can communicate with the data plane app tier of the data plane VCN via VNICs that can be contained in the data plane mirror app tier and the data plane app tier.

In accordance with an embodiment, users of the system, or customers, can make requests, for example, create, read, update, or delete (CRUD) operations through the public Internet that can communicate the requests to the metadata management service. The metadata management service can communicate the request to the control plane VCN through the Internet gateway. The request can be received by the LB subnet(s) contained in the control plane DMZ tier. The LB subnet(s) may determine that the request is valid, and in response to this determination, the LB subnet(s) can transmit the request to app subnet(s) contained in the control plane app tier. If the request is validated and requires a call to the public Internet, the call to the Internet may be transmitted to the NAT gateway that can make the call to the Internet. Metadata to be stored by the request can be stored in the DB subnet(s).

In accordance with an embodiment, the data plane mirror app tier can facilitate direct communication between the control plane VCN and the data plane VCN. For example, changes, updates, or other suitable modifications to configuration may be desired to be applied to the resources contained in the data plane VCN. By means of a VNIC, the control plane VCN can directly communicate with, and can thereby execute the changes, updates, or other suitable modifications to configuration to, resources contained in the data plane VCN.

In accordance with an embodiment, the control plane VCN and the data plane VCN can be contained in the service tenancy. In this case, the user, or the customer, of the system may not own or operate either the control plane VCN or the data plane VCN. Instead, the cloud infrastructure provider may own or operate the control plane VCN and the data plane VCN, both that may be contained in the service tenancy. This embodiment can enable isolation of networks that may prevent users or customers from interacting with the resources of other users or other customers. Also, this embodiment may allow users or customers of the system to store databases privately without needing to rely on the public Internet for storage that may not provide a desired level of threat prevention.

In accordance with an embodiment, the LB subnet(s) contained in the control plane VCN can be configured to receive a signal from the service gateway. In this embodiment, the control plane VCN and the data plane VCN may be configured to be called by a customer of the cloud infrastructure provider without calling the public Internet. Customers of the cloud infrastructure provider may desire this embodiment since the database(s) that the customers use may be controlled by the cloud infrastructure provider and may be stored on the service tenancy that may be isolated from the public Internet.

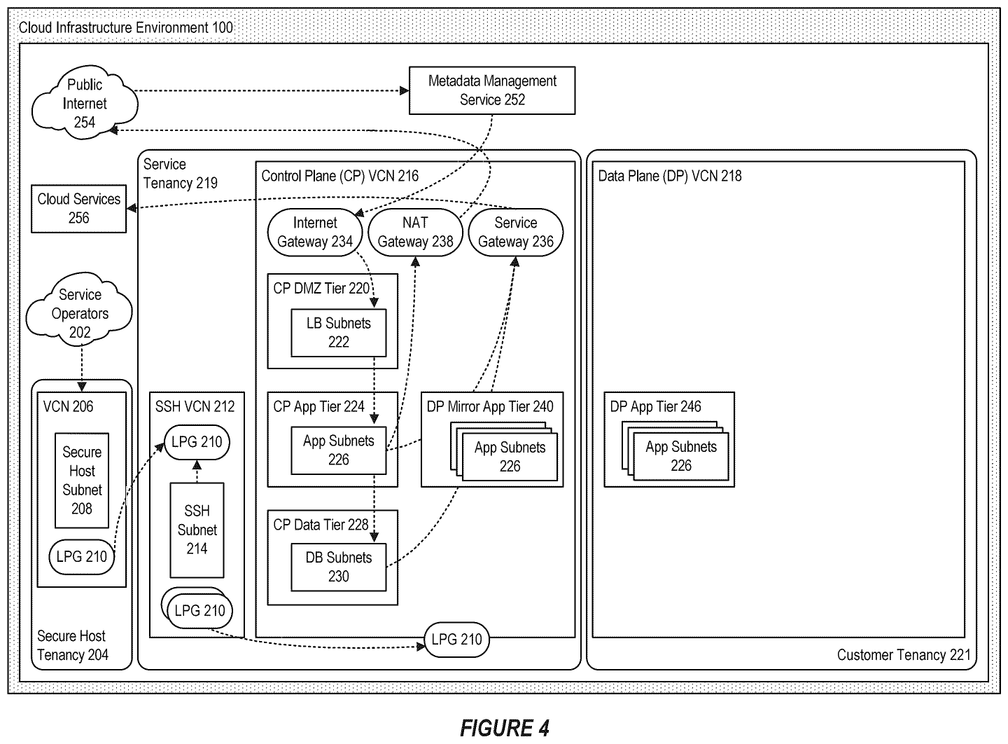

FIG. 4 illustrates another example of a cloud infrastructure architecture in accordance with an embodiment.

As illustrated in FIG. 4, in accordance with an embodiment, the data plane VCN can be contained in the customer tenancy 221. In this case, the cloud infrastructure provider may provide the control plane VCN for each customer, and the cloud infrastructure provider may, for each customer, set up a unique compute instance that is contained in the service tenancy. Each compute instance may allow communication between the control plane VCN, contained in the service tenancy, and the data plane VCN that is contained in the customer tenancy. The compute instance may allow resources provisioned in the control plane VCN contained in the service tenancy to be deployed or otherwise used in the data plane VCN contained in the customer tenancy.

In accordance with an embodiment, a customer of the cloud infrastructure provider may have databases that are managed and operated within the customer tenancy. In this example, the control plane VCN can include the data plane mirror app tier that can include app subnet(s). The data plane mirror app tier can reside in the data plane VCN, but the data plane mirror app tier may not be provided in the data plane VCN. That is, the data plane mirror app tier may have access to the customer tenancy, but the data plane mirror app tier may not exist in the data plane VCN or be owned or operated by the customer. The data plane mirror app tier may be configured to make calls to the data plane VCN, but the data plane mirror app tier may not be configured to make calls to any entity contained in the control plane VCN. The customer may desire to deploy or otherwise use resources in the data plane VCN that are provisioned in the control plane VCN, and the data plane mirror app tier can facilitate the desired deployment, or other usage of resources, by the customer.

In accordance with an embodiment, a customer of the cloud infrastructure provider can apply filters to the data plane VCN. In this embodiment, the customer can determine what the data plane VCN can access, and the customer may restrict access to the public Internet from the data plane VCN. The cloud infrastructure provider may not be able to apply filters or otherwise control access of the data plane VCN to any outside networks or databases. Applying filters and controls by the customer onto the data plane VCN, contained in the customer tenancy, can help isolate the data plane VCN from other customers and from the public Internet.

In accordance with an embodiment, cloud services can be called by the service gateway to access services that may not exist on the public Internet, on the control plane VCN, or on the data plane VCN. The connection between cloud services and the control plane VCN or the data plane VCN may not be continuous. Cloud services may exist on a different network owned or operated by the cloud infrastructure provider. Cloud services may be configured to receive calls from the service gateway and may be configured to not receive calls from the public Internet. Some cloud services may be isolated from other cloud services, and the control plane VCN may be isolated from cloud services that may not be in the same region as the control plane VCN.

For example, in accordance with an embodiment, the control plane VCN may be located in a “Region 1,” and a cloud service “Deployment 1,” may be located in Region 1 and in “Region 2.” If a call to Deployment 1 is made by the service gateway contained in the control plane VCN located in Region 1, the call may be transmitted to Deployment 1 in Region 1. In this example, the control plane VCN, or Deployment 1 in Region 1, may not be communicatively coupled to, or otherwise in communication with, Deployment 1 in Region 2.

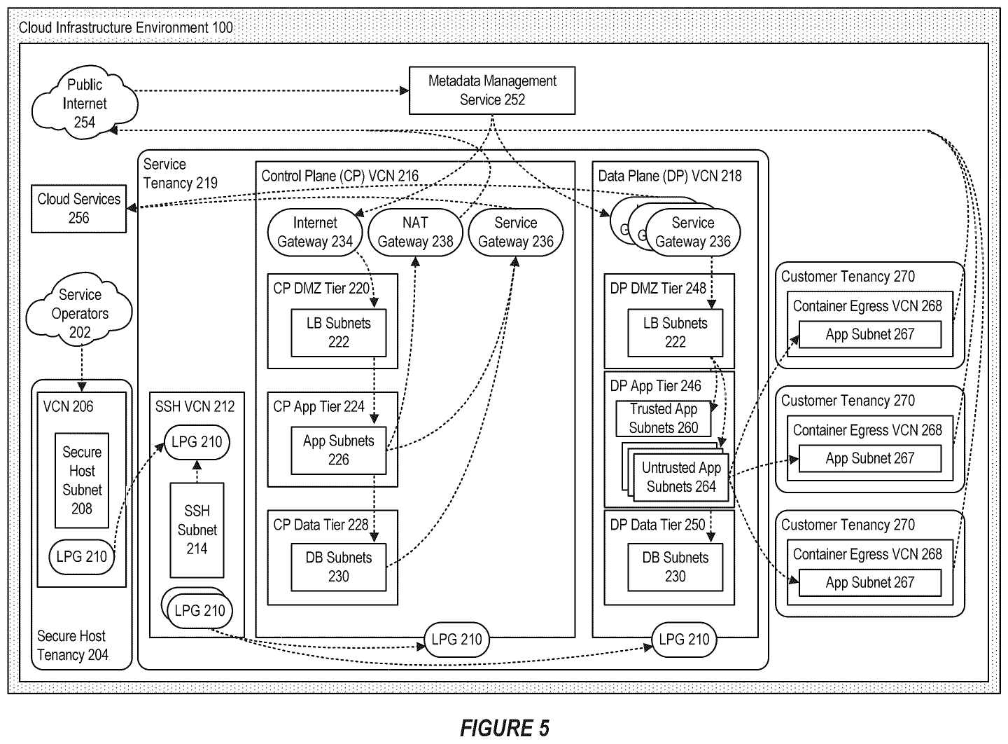

FIG. 5 illustrates another example of a cloud infrastructure architecture in accordance with an embodiment.

As illustrated in FIG. 5, in accordance with an embodiment, the trusted app subnets 260 can be communicatively coupled to the service gateway contained in the data plane VCN, the NAT gateway contained in the data plane VCN, and DB subnet(s) contained in the data plane data tier. The untrusted app subnets 264 can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include one or more primary VNICs (1)-(N) that can be communicatively coupled to tenant virtual machines (VMs). Each tenant VM can be communicatively coupled to a respective app subnet 267 (1)-(N) that can be contained in respective container egress VCNs 268 (1)-(N) that can be contained in respective customer tenancies 270 (1)-(N). Respective secondary VNICs can facilitate communication between the untrusted app subnet(s) contained in the data plane VCN and the app subnet contained in the container egress VCN. Each container egress VCN can include a NAT gateway that can be communicatively coupled to the public Internet.

In accordance with an embodiment, the public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the data plane VCN can be integrated with customer tenancies. This integration can be useful or desirable for customers of the cloud infrastructure provider in cases that may require additional support when executing code. For example, the customer may provide code to run that may be potentially destructive, may communicate with other customer resources, or may otherwise cause undesirable effects.

In accordance with an embodiment, a customer of the cloud infrastructure provider may grant temporary network access to the cloud infrastructure provider and request a function to be attached to the data plane app tier. Code to run the function may be executed in the VMs and may not be configured to run anywhere else on the data plane VCN. Each VM may be connected to one customer tenancy. Respective containers (1)-(N) contained in the VMs may be configured to run the code. In this case, there can be a dual isolation (e.g., the containers running code, where the containers may be contained in at least the VM that are contained in the untrusted app subnet(s)) that may help prevent incorrect or otherwise undesirable code from damaging the network of the cloud infrastructure provider or from damaging a network of a different customer. The containers may be communicatively coupled to the customer tenancy and may be configured to transmit or receive data from the customer tenancy. The containers may not be configured to transmit or receive data from any other entity in the data plane VCN. Upon completion of running the code, the cloud infrastructure provider may dispose of the containers.

In accordance with an embodiment, the trusted app subnet(s) may run code that may be owned or operated by the cloud infrastructure provider. In this embodiment, the trusted app subnet(s) may be communicatively coupled to the DB subnet(s) and be configured to execute CRUD operations in the DB subnet(s). The untrusted app subnet(s) may be communicatively coupled to the DB subnet(s) and configured to execute read operations in the DB subnet(s). The containers that can be contained in the VM of each customer and that may run code from the customer may not be communicatively coupled with the DB subnet(s).

In accordance with an embodiment, the control plane VCN and the data plane VCN may not be directly communicatively coupled, or there may be no direct communication between the control plane VCN and the data plane VCN. However, communication can occur indirectly, wherein an LPG may be established by the cloud infrastructure provider that can facilitate communication between the control plane VCN and the data plane VCN. In another example, the control plane VCN or the data plane VCN can make a call to cloud services via the service gateway. For example, a call to cloud services from the control plane VCN can include a request for a service that can communicate with the data plane VCN.

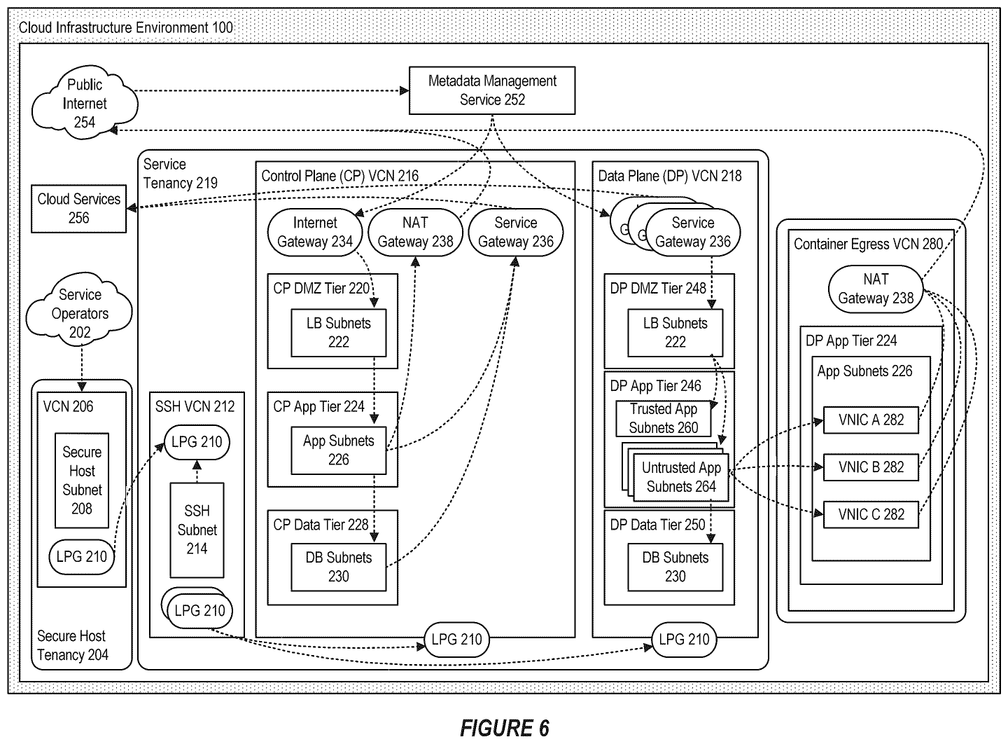

FIG. 6 illustrates another example of a cloud infrastructure architecture in accordance with an embodiment.

As illustrated in FIG. 6, in accordance with an embodiment, the trusted app subnet(s) can be communicatively coupled to the service gateway contained in the data plane VCN, the NAT gateway contained in the data plane VCN, and DB subnet(s) contained in the data plane data tier. The untrusted app subnet(s) can be communicatively coupled to the service gateway contained in the data plane VCN and DB subnet(s) contained in the data plane data tier. The data plane data tier can include DB subnet(s) that can be communicatively coupled to the service gateway contained in the data plane VCN.

In accordance with an embodiment, untrusted app subnet(s) can include primary VNICs that can be communicatively coupled to tenant virtual machines (VMs) residing within the untrusted app subnet(s). Each tenant VM can run code in a respective container and be communicatively coupled to an app subnet that can be contained in a data plane app tier that can be contained in a container egress VCN 280. Respective secondary VNICs 282 (1)-(N) can facilitate communication between the untrusted app subnet(s) contained in the data plane VCN and the app subnet contained in the container egress VCN. The container egress VCN can include a NAT gateway that can be communicatively coupled to the public Internet.

In accordance with an embodiment, the Internet gateway contained in the control plane VCN and contained in the data plane VCN can be communicatively coupled to a metadata management service that can be communicatively coupled to the public Internet. The public Internet can be communicatively coupled to the NAT gateway contained in the control plane VCN and contained in the data plane VCN. The service gateway contained in the control plane VCN and contained in the data plane VCN can be communicatively coupled to cloud services.

In accordance with an embodiment, the pattern illustrated in FIG. 6 may be considered an exception to the pattern illustrated in FIG. 5 and may be desirable for a customer if the cloud infrastructure provider cannot directly communicate with the customer (e.g., a disconnected region). The respective containers that are contained in the VMs for each customer can be accessed in real-time by the customer. The containers may be configured to make calls to respective secondary VNICs contained in app subnet(s) of the data plane app tier that can be contained in the container egress VCN. The secondary VNICs can transmit the calls to the NAT gateway that may transmit the calls to the public Internet. In this example, the containers that can be accessed in real-time by the customer can be isolated from the control plane VCN and can be isolated from other entities contained in the data plane VCN. The containers may also be isolated from resources from other customers.

In other examples, the customer can use the containers to call cloud services. In this example, the customer may run code in the containers that request a service from cloud services. The containers can transmit this request to the secondary VNICs that can transmit the request to the NAT gateway that can transmit the request to the public Internet. The public Internet can be used to transmit the request to LB subnet(s) contained in the control plane VCN via the Internet gateway. In response to determining that the request is valid, the LB subnet(s) can transmit the request to app subnet(s) that can transmit the request to cloud services via the service gateway.

It should be appreciated that IaaS architectures depicted in the above figures may have other components than those depicted. Further, the embodiments shown in the figures are some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner.

### Private Label Cloud Environments

In accordance with an embodiment, a cloud infrastructure environment can be used to provide dedicated cloud environments, for example, as one or more private label cloud environments for use by tenants of the cloud infrastructure environment in accessing subscription-based software products, services, or other offerings associated with the cloud infrastructure environment.

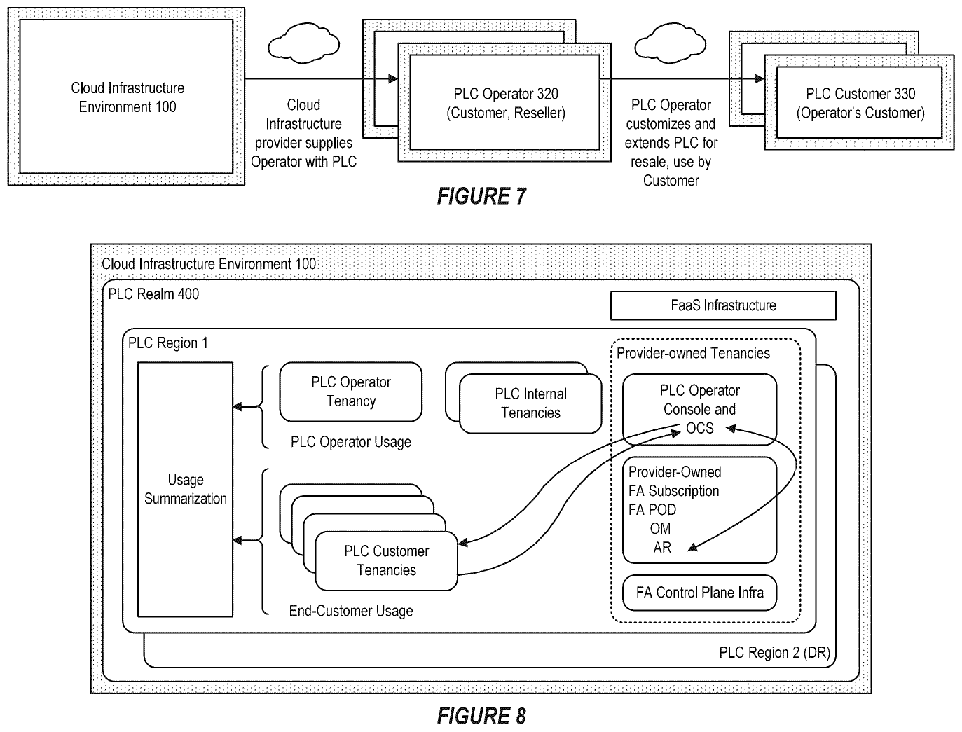

FIG. 7 illustrates how the system can provide dedicated or private label cloud environments for use by tenants or customers of a cloud infrastructure environment in accordance with an embodiment.

As illustrated in FIG. 7, in accordance with an embodiment, a cloud infrastructure provider (e.g., OCI) can supply a PLC operator 320, for example an OCI customer operating as a reseller, with one or more private label cloud (PLC) environments. The PLC operator/reseller can then customize and extend the private label cloud for use by (their) customer 330 for use in accessing subscription-based software products, services, or other offerings associated with the cloud infrastructure environment.

For purposes of illustration, examples of such subscription-based products, services, or other offerings may include various Oracle Cloud Infrastructure software products, Oracle Fusion Applications products, or other types of products or services that allow customers to subscribe to usage of those products or services.

FIG. 8 further illustrates the use of private label cloud realms for use by tenants or customers of a cloud infrastructure environment in accordance with an embodiment.

As illustrated in FIG. 8, in accordance with an embodiment, the system can include a cloud subscription service or component, such as an Oracle Cloud Subscriptions (OCS) service or component, that exposes one or more subscription management APIs for creating orders used to onboard new customers or to launch a workflow that creates a subscription and orchestrates billing and pricing service or other components for use with a PLC realm 400.

In accordance with an embodiment, when a PLC operator or their customer requests a PLC environment, the system creates a PLC realm for use with one or more provider-owned tenancies. A realm is a logical collection of one or more cloud regions that are isolated from each other and do not allow customer content to traverse realm boundaries to a region outside that realm. Each realm is accessed separately. PLC operators access cloud resources and services through a cloud tenancy. A cloud tenancy is a secure and isolated partition of a cloud infrastructure environment, and it only exists in a single realm. Within this tenancy, operators can access services and deploy workloads across all regions within that realm if policies allow.

In accordance with an embodiment, a first step in the process is to create an operator tenancy for the PLC operator before the realm and associated regions are turned over to them for subsequent management. The PLC operator then becomes the administrator of this tenancy with the ability to view and manage everything that happens within that realm, including their customer accounts and usage by those customers of cloud resources.

Generally, once the realm has been turned over or provided to the PLC operator, the cloud infrastructure provider cannot subsequently access the data within the operator tenancy unless the operator authorizes the cloud infrastructure provider to do so, for example, to provide troubleshooting for issues that may arise.

In accordance with an embodiment, the PLC operator can then create additional internal tenancies, intended for their own use internally, for example, to assess what the end customer experience will be, to provide a sales demo tenancy, or to operate a database for their own internal use. The operator can also create one or more customer tenancies that the end customer will be the administrator for. Cloud infrastructure usage metrics, for example, compute usage, storage usage, and usage of other infrastructure resources, may be consolidated by the operator, reflecting both operator usage and customer usage. Cloud infrastructure usage may be reported to the cloud infrastructure provider.

In accordance with an embodiment, a user interface or console can be provided that allows the PLC operator to manage its customer accounts and customer-offered services. A cloud infrastructure provider can also use a cloud infrastructure tenancy, for example, a Fusion Applications tenancy, to install any needed infrastructure services for use by the operator and their customers.

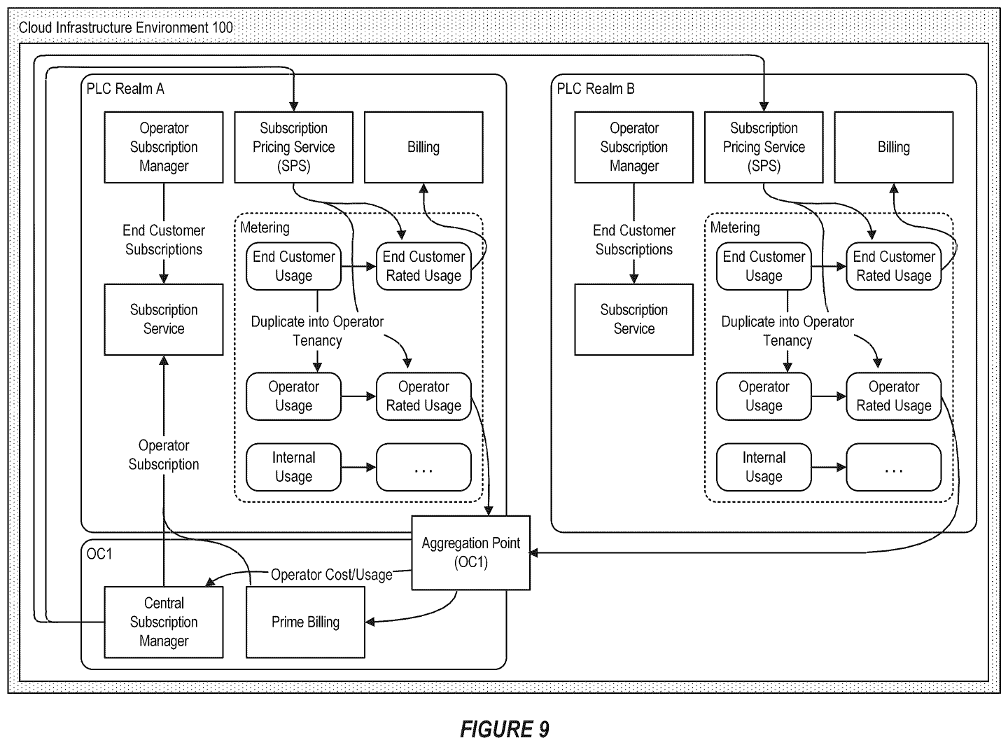

FIG. 9 further illustrates the use of private label cloud realms for use by tenants or customers of a cloud infrastructure environment in accordance with an embodiment.

As illustrated in FIG. 9, in accordance with an embodiment, a cloud subscription service or component exposes one or more subscription management APIs for creating orders used to onboard new customers or to launch a workflow that creates a subscription and orchestrates billing and pricing services or other components.

In accordance with an embodiment, the system can also include a billing service or component that operates upon a billing account or logical container of subscriptions and preferences used to produce an invoice for a customer.

In accordance with an embodiment, the system can also include a subscription pricing service (SPS) or component that operates upon a product catalog that defines the products that can be purchased by a customer. The subscription pricing service can also be used to provide a price list (e.g., a rate card) that the pricing service also owns.

In accordance with an embodiment, to support the sales process used to create a subscription in a PLC realm, products can be selected from a product hub. Once an order is created, a subscription is created in cloud subscription service that thereafter manages the life cycle of that subscription and provisions what needs to be provisioned in downstream services. The SPS component then manages the aspects of pricing and usage for use in charging the end cost to the PLC operator or their ability to charge their customers. Usage events are forwarded to the billing service or component, where, depending on the billing preferences of the subscription, invoices are created and pushed to an accounts receivables component.

In accordance with an embodiment, although the services that are offered in a realm report their usage to a metering service or component, such usage does not have any price associated with it. A rating process determines how much each specific event costs, for example, by applying rate cards, determines a unit and cost for that subscription, associates the cost to that record, and then forwards that to the billing service or component.

As further illustrated in FIG. 9, in accordance with an embodiment, a PLC operator may control multiple realms A, B. For, example an operator that operates in multiple countries may wish to operate a data center that is completely isolated for the United States of America and a separate data center that is completely isolated for Europe, for example, to address governance or regulatory requirements. In accordance with an embodiment, the usage associated with these multiple realms can be aggregated for use in billing the operator.

The examples of various systems illustrated above are provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### Private Label Cloud Subscriptions

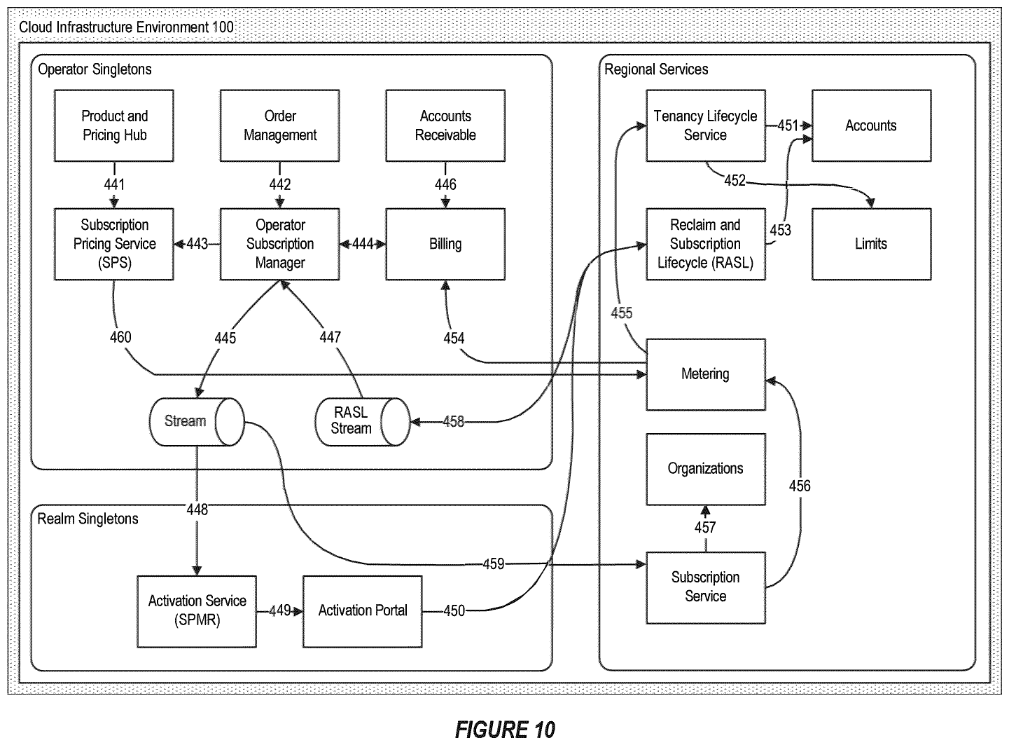

FIG. 10 illustrates a system for providing access to software products or services in a cloud computing or other computing environment in accordance with an embodiment.

As illustrated in FIG. 10, in accordance with an embodiment, the system can be provided as a cloud computing or other computing environment, referred to herein in some embodiments as a platform, that supports the use of subscription-based products, services, or other offerings.

Examples of such subscription-based products, services, or other offerings may include various Oracle Cloud Infrastructure (OCI) software products, Oracle Fusion Applications products, or other types of products or services that allow customers to subscribe to usage of those products or services.

In accordance with an embodiment, a subscription can include artifacts, such as products, commits, billing model, and state. The cloud subscription service can expose one or more subscription management APIs for creating orders used to onboard new customers or to launch a workflow that creates a subscription and orchestrates creating the proper footprints in billing and pricing service or components as further described below.

In accordance with an embodiment, the billing service or component operates upon a billing account or logical container of subscriptions and preferences used to produce an invoice. Each billing account generates one or more invoices per billing cycle. The billing service includes a first pipeline that accepts usage and cost from a metering service or component. Usage may be accepted through a REST API or another interface. The billing service writes the usage to a database from which balances may be calculated and aggregated by the billing service or other services. The billing service may include a second pipeline responsible for taking the aggregated usage and commitments and calculating charges over one or more billing intervals.

In accordance with an embodiment, the subscription pricing service (SPS) or component operates upon a product catalog that defines the products that can be purchased by a customer. The product catalog forms the backbone of a price list (i.e., rate card) that the pricing service also owns. Rate cards are modeled as pricing rules on top of public list prices. The pricing service maintains a single price list for each product; new product prices can be added and existing prices changed. The price list has a full history, the latest version being the current rate card. Since some contracts may require a snapshot of the rate card be taken, the pricing service handles this by recording the time a customer's rate card is created and then querying the price list at that time.

In accordance with an embodiment, the SPS or pricing service is responsible for providing information about products, global price lists, and end customer subscription specific price lists and discounts. For example, in accordance with an embodiment, the SPS can synchronize product information from a product hub (e.g., an Oracle Fusion Product Hub) and a global price list from a pricing hub (e.g., an Oracle Fusion Pricing Hub).

In accordance with an embodiment, the cloud subscription service operates as an upstream service to receive new order requests, for example, from an Oracle Fusion Order Management environment. The cloud subscription service can provide subscription information to the SPS service. Subscription details like time of quote, configuration, and subscription type (Commitment, PayG) help SPS to determine an effective base price (Rate Card) for the subscription. The cloud subscription service can also send discounts for subscriptions received, for example, from Oracle Fusion Order Management, that SPS stores as a pricing rule entity.

In accordance with an embodiment, the SPS service runs as a background process to manage a rate cards service or component responsible for generating rate cards for new subscriptions and updating when new price changes occur. The SPS service can expose APIs to access rate cards and pricing rules. A metering in-line rating engine can utilize these APIs to get subscription-specific rate cards and pricing rules using this data for cost calculations.

In accordance with an embodiment, additional SPS components can include, for example, a Pricing/Product Hub Oracle Integration Cloud (OIC) integration component, that allows a PLC operator entity providing subscription-based products, services, or other offerings within the environment to manage their product and price list, for example, as provided by an Oracle Fusion Product Hub and Oracle Fusion Pricing Hub, respectively.

For example, in accordance with such an embodiment, an SPS OIC product integration flow can listen to create/update events in the Product Hub and make calls to an SPS product API. Similarly, an SPS OIC pricing integration flow can pull new price list creations from the Pricing Hub and call respective SPS pricing APIs.

In accordance with an embodiment, the system can also include an SPS core module that provides APIs to manage and access pricing entities. Pricing can be accessed by internal services, such as an inline rating engine.

In accordance with an embodiment, the system can also include a rate card manager component. The SPS service maintains the single base price for a product at a given time. However, product prices for subscriptions are dependent on a base price at quote configuration time and price list change policy attributes of subscriptions. The SPS service internally maintains the price to be used for subscriptions using these properties. Such price lists are grouped in a rate card. The rate card manager can create and maintain the rate card as well as listen to price list changes and update existing rate cards with the new price. It also listens to new subscriptions and assigns the rate card based on subscription properties.

In accordance with an embodiment, the system can also include a rule decoder engine. The SPS service is responsible for managing pricing rules for a subscription, including discounts offered to an end customer. Pricing rules eligibility can be based on attributes of Products, like Discount group, Product Category, or specific SKUs. Internally, SPS needs to identify the list of products these rules will be applicable. To accomplish this, the rule decoder engine can compile the pricing rules in a format such that an in-line rating engine can consume for cost calculation. This compilation process can be triggered when products or pricing rules get created/updated.

As illustrated by way of example in FIG. 10, in accordance with an embodiment: at 441, a product and price information managed in, e.g., Fusion Applications, is sent to the SPS component. At 442, orders are sent to the cloud subscription service component to create subscriptions, rate cards, and billing accounts. At 443, pricing configuration and pricing rules are sent to SPS for new orders. At 444, the cloud subscription service is used to set up a billing account in the billing service or component. At 445, the cloud subscription service publishes events to a cloud infrastructure streaming component. At 446, charge data is sent to an accounts receivable component to generate invoices. At 447, cloud subscription service consumes reclaim and subscription lifecycle (RASL) events from cloud infrastructure streaming. At 448, an activation service reads the cloud subscription service event stream. At 449, a customer gets activation data from a portal. At 450, a tenancy lifecycle service provisions a tenancy as part of the subscription activation. At 451, the tenancy lifecycle service creates an accounts footprint during account provisioning. At 452, the tenancy lifecycle service sets a limits template during account provisioning. At 453, the accounts component acts as a downstream RASL client to handle legacy reclamation. At 454, aggregated cost and usage is sent to the billing service or component. At 455, an organization can create child tenancies using the tenancy lifecycle service. At 456, a metering service or component gets subscription mapping data. At 457, the subscription service gets organization data for subscription mappings. At 458, RASL reads cloud subscription service event stream. At 459, the subscription service reads cloud subscription service event stream; and at 460, the metering service or component gets a rate card data for each subscription that can then be used in charging the end cost to the PLC operator or their ability to charge their customers.

The above example is provided for purposes of illustrating a computing environment that can be used to provide dedicated or private label cloud environments for use by tenants of a cloud infrastructure in accessing subscription-based software products, services, or other offerings associated with the cloud infrastructure environment. In accordance with other embodiments, the various components, processes, and features described herein can be used with other types of cloud computing environments.

### 3. System Architecture for Scheduling System Maintenance Operations in a Cloud Environment

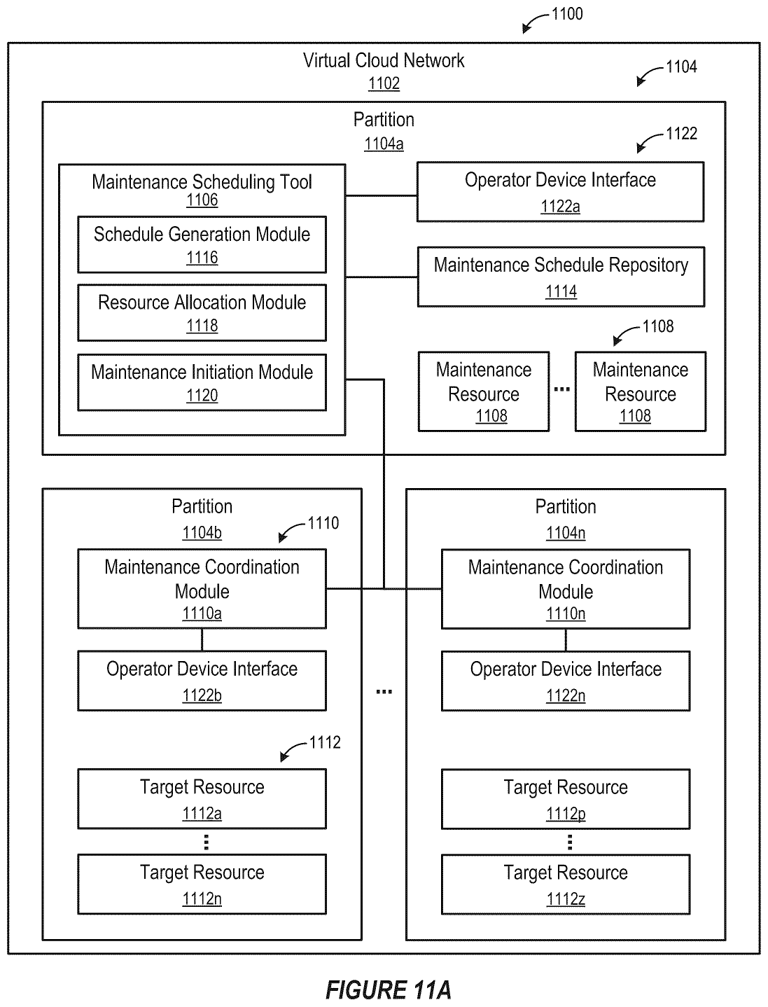

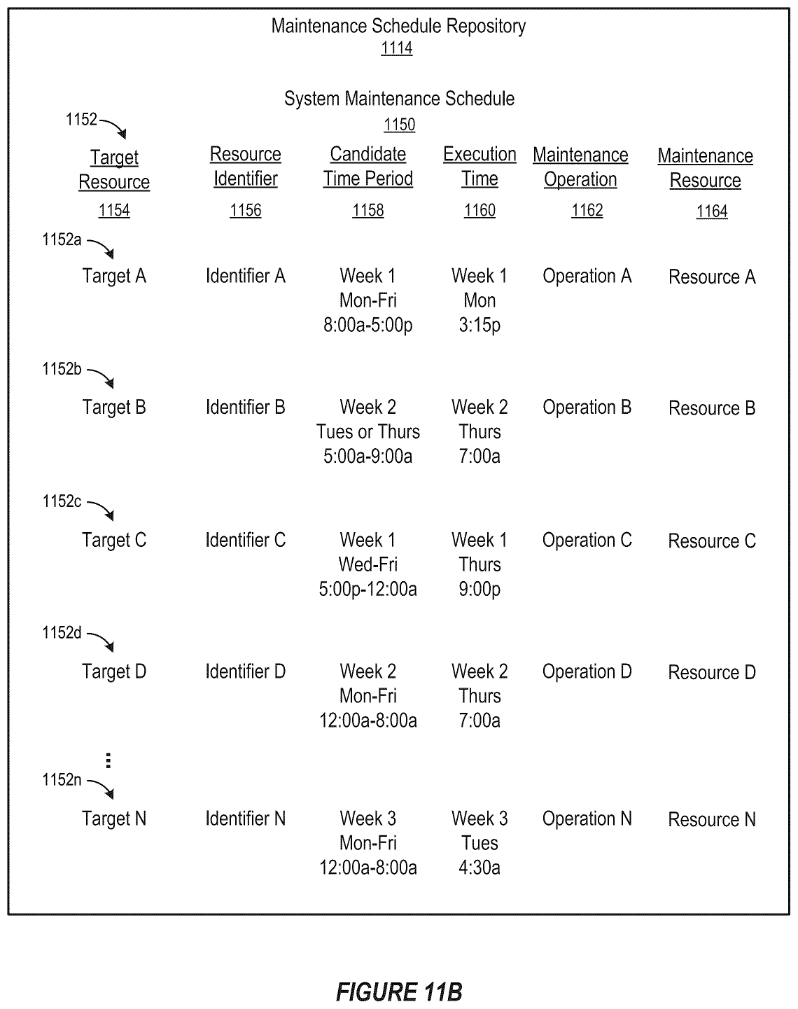

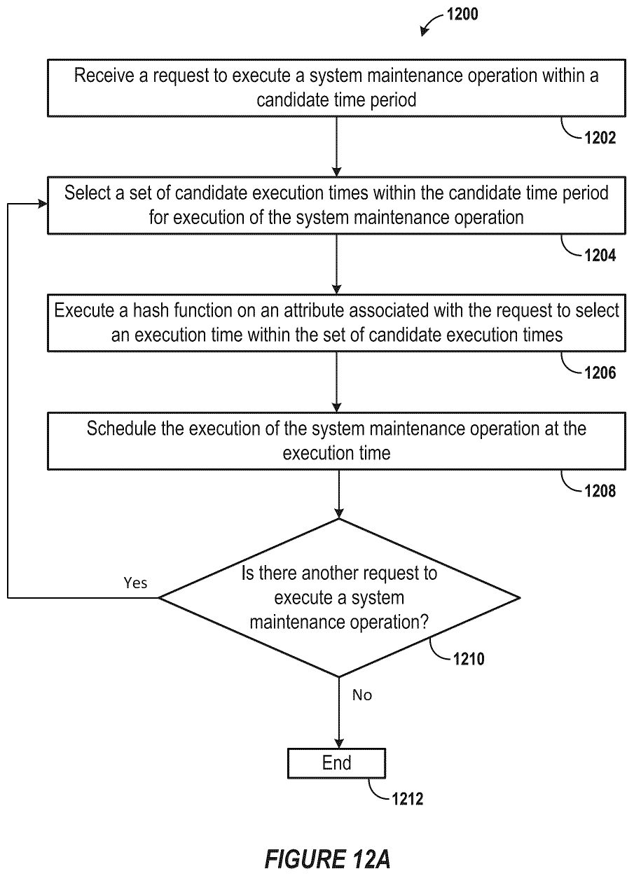

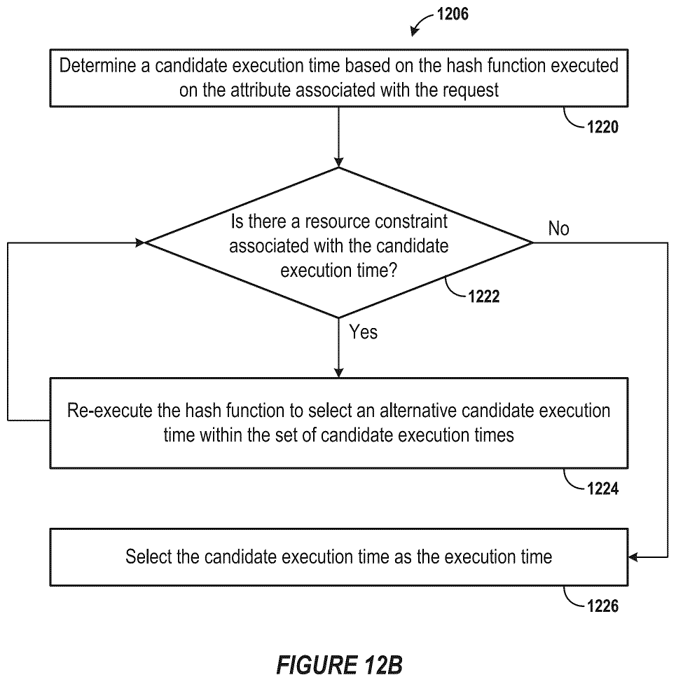

FIGS. 11A and 11B illustrate a system 1100 that includes features for scheduling system maintenance operations in a cloud environment in accordance with one or more embodiments. In one or more embodiments, the system 1100 refers to hardware and/or software configured to perform operations described herein. Examples of operations are described below with reference to FIGS. 12A and 12B. In addition to the features described with reference to FIGS. 11A and 11B, the system 1100 may include one or more features described above in Section 2, titled “Example Cloud Environments.”

In one or more embodiments, the system 1100 may include more or fewer components than the components described with reference to FIGS. 11A and 11B. The components described with reference to FIGS. 11A and 11B may be local to or remote from each other. The components described with reference to FIGS. 11A and 11B may be implemented in software and/or hardware. The components of system 1100 may be distributed over multiple applications and/or machines. Multiple components may be combined into one application and/or machine. Operations described with respect to one component may instead be performed by another component.

### A. Example Maintenance Scheduling Architecture

Referring to FIG. 11A, the system 1100 includes a virtual cloud network 1102 with a set of partitions 1104 deployed in the virtual cloud network 1102. One or more of the partitions 1104 may be allocated to a PLC operator or customer. Additionally, or alternatively, one or more of the partitions may be allocated to a cloud infrastructure provider. In one example, partition 1104a is allocated to a cloud infrastructure provider, partition 1104b is allocated to a first PLC operator or customer, and partition 1104n is allocated to a second PLC operator or customer. The partitions 1104 represent logically or physically isolated portions of the virtual cloud network 1102. In one example, the partitions include realms, such as PLC realms, that isolate portions of the virtual cloud network 1102 as between different entities, such as different PLC operators or customers. Additionally, or alternatively, the partitions 1104 may include tenant partitions, or tenancies, that isolate portions of the virtual cloud network 1102 as between different entities, or tenants, such as PLC operators or customers. Additionally, or alternatively, the partitions 1104 may include one or more of the following: service partitions that isolate different services or workloads, geographic partitions that isolate a portion of the virtual cloud network 1102 corresponding to a particular geographic region, or network partitions that isolate the virtual cloud network 1102 into separate segments or subnets.

As shown in FIG. 11A, one or more of the partitions 1104 includes a maintenance scheduling tool 1106 for scheduling system maintenance operations to be performed in various partitions 1104 and a set of one or more maintenance resources 1108 that may be utilized to perform the system maintenance operations. Additionally, one or more of the partitions 1104 includes a maintenance coordination module 1110 that provides information to the maintenance scheduling tool 1106 for use in scheduling system maintenance operations in the partition 1104. The maintenance scheduling tool 1106 may schedule system maintenance operations for the partition 1104, where the maintenance scheduling tool 1106 is located and/or for other partitions 1104 of the virtual cloud network 1102. In one example, a partition 1104 allocated to a cloud infrastructure provider includes the maintenance scheduling tool 1106 and a set of maintenance resources 1108, and one or more partitions 1104 allocated to PLC operators or customers include a maintenance coordination module 1110. As shown in FIG. 11A, partition 1104a includes the maintenance scheduling tool 1106, and partition 1104b and partition 1104n include a maintenance coordination module 1110. Additionally, or alternatively, a partition 1104 that includes a maintenance scheduling tool 1106 and/or one or more maintenance resources 1108 may also include a maintenance coordination module 1110.

One or more of the partitions 1104 include a set of target resources 1112 that may be a target of various system maintenance operations. As shown in FIG. 11A, partition 1104b includes target resource 1112a and target resource 1112n, and partition 1104n includes target resource 1112p and target resource 1112z. Additionally, or alternatively, one or more target resources 1112 may be located in partition 1104a. The maintenance scheduling tool 1106 schedules system maintenance operations that are performed on the various target resources 1112 of the various partitions 1104. Additionally, the maintenance scheduling tool 1106 may determine maintenance resources 1108 to be utilized to perform the system maintenance operations on the target resources 1112. The maintenance coordination modules 1110 for a particular partition 1104 provides information to the maintenance scheduling tool 1106 regarding system maintenance operation that are scheduled for the various target resources 1112 in the partition 1104. In one example, a maintenance coordination module 1110 for a particular partition 1104 provides one or more time periods for execution of system maintenance operations on one or more target resources 1112 in the partition 1104. The one or more time periods may include one or more user-specified time periods. The one or more time periods may recur periodically or intermittently, such as momentarily, hourly, daily, weekly, monthly, or annually. Additionally, or alternatively, the maintenance coordination module 1110 for a particular partition 1104 may provide information pertaining to the target resources 1112 in the partition 1104 that may be a target for various system maintenance operations in the partition 1104. The information pertaining to the target resources 1112 may include resource identifiers corresponding, respectively, to the target resources 1112.

The virtual cloud network 1102 includes a maintenance schedule repository 1114 that stores maintenance schedules generated by the maintenance scheduling tool 1106. The maintenance schedules may include, for various target resources 1112, a data structure that includes one or more of the following data elements: a resource identifier that identifies a particular target resource 1112, a time window for performing system maintenance operations on the target resource 1112, an execution time for performing system maintenance operations on the target resource 1112, one or more system maintenance operations to be performed on the target resource 1112, or a maintenance resource 1108 allocated for performing the system maintenance operations on the target resource 1112. Additionally, or alternatively, the maintenance schedule repository 1114 may store one or more data structures in addition to the system maintenance schedules that include one or more of the forgoing data elements. An example maintenance schedule repository 1114 is described further below with reference to FIG. 11B.

Referring further to FIG. 11A, the maintenance scheduling tool 1106 includes one or more of the following: a schedule generation module 1116, a resource allocation module 1118, or a maintenance initiation module 1120. The schedule generation module 1116 generates maintenance schedules for system maintenance operations to be performed on various target resources 1112. The resource allocation module 1118 allocates maintenance resources 1108 for performing the system maintenance operations. The maintenance initiation module 1120 initiates system maintenance operations in accordance with the various maintenance schedules.

i. Example Schedule Generation Module

The schedule generation module 1116 may generate maintenance schedules for various target resources 1112 based on the time windows corresponding to the target resources 1112 for performing system maintenance operations. The schedule generation module 1116 may determine the time windows from the maintenance schedule repository 1114. Additionally, or alternatively, the schedule generation module 1116 may receive the time windows from the maintenance coordination modules 1110 corresponding to various partitions 1104, where the various target resources 1112 are located. The schedule generation module 1116 may store the time windows received from the maintenance coordination modules 1110 in the maintenance schedule repository 1114.

The schedule generation module 1116 may select a set of candidate execution times for performing system maintenance operations for a target resource 1112 based on a candidate time period, or time window, corresponding to the target resource 1112. In one example, the set of candidate execution times may represent a subset of times from the candidate time period. Additionally, or alternatively, the set of candidate execution times may represent a series of time increments from the candidate time period. In one example, the set of candidate execution times may include a set of N-minute time increments corresponding to at least a portion of the candidate time period. The N-minute time increments may represent candidate execution times for initiating execution of system maintenance operations. In one example, the time increments include one or more of the following: 6-minute time increments, 10-minute time increments, 15-minute increments, 30-minute increments, 60-minute increments, 2-hour increments, 4-hour increments, 8-hour increments, or 12-hour increments. Additionally, or alternatively, the candidate time period may include one or more days of the week and/or one or more weeks of a month. In one example, the candidate time period includes a particular week of the month, one or more days of the week, and one or more portions of the day.

An example candidate time period for performing system maintenance may include the following: the first week of the month (a particular week of the month); on Monday, Wednesday, or Friday (one or more days of the week); from 3:00 am to 7:00 am or from 7:00 pm to 11:00 pm (one or more portions of the day). An example set of candidate execution times may include 15-minute time increments from the one or more portions of the day (e.g., 3:00 am, 3:15 am, 3:30 am, 3:45 am, 4:00 am, 4:15 am, 4:30 am, 4:45 am, 5:00 am, 5:15 am, 5:30 am, 5:45 am, 6:00 am, 6:15 am, 6:30 am, 6:45 am, 7:00 am, 7:00 pm, 7:15 pm, 7:30 pm, 7:45 pm, 8:00 pm, 8:15 pm, 8:30 pm, 8:45 pm, 9:00 pm, 9:15 pm, 9:30 pm, 9:45 pm, 10:00 pm, 10:15 pm, 10:30 pm, 10:45 pm, and 11:00 pm). The example set of candidate execution times determined from the 15-minute increments includes (34) candidate execution times.

The schedule generation module 1116 may select an execution time from the set of candidate execution times by executing a hash function on one or more attributes associated with target resource 1112. Additionally, or alternatively, the schedule generation module 1116 may execute the hash function on one or more attributes associated with a request to execute system maintenance operations on the target resource 1112 to select the execution time. The one or more attributes that the schedule generation module 1116 executes the hash function upon may include one or more attributes that have a stable value such as a value that does not change over time. By executing the hash function on an attribute that has a stable value, the hash function may produce the same result with different instances of executing the hash function. The hash function may be executed on the same one or more attributes for different requests for system maintenance operations on the target resource 1112. In addition, based on the stable value of the one or more attributes, the same execution time may be selected for the different requests. Additionally, hash function may provide a semi-random distribution of execution times for executing a set of system maintenance operations for various target resource 1112 and/or for various requests to execute system maintenance operations on various target resource 1112.

The one or more attributes that the hash function is executed upon to select an execution time for performing system maintenance operations on a target resource 1112 may include one or more of the following: a resource identifier corresponding to the target resource 1112, a network address corresponding to the target resource 1112, a label or tag assigned to the target resource 1112, or a creation timestamp corresponding to the target resource 1112 as well as combinations of these. In one example, the schedule generation module 1116 executes the hash function on the resource identifier corresponding to the target resource 1112.

In one example, the schedule generation module 1116 selects the execution time for performing system maintenance operations on a target resource 1112 based on a product of the hash function. In one example, the hash function may include a hash operation and a modulo operation. The hash operation may generate a hash value of the one or more attributes corresponding to the target resource 1112 and/or the request to execute system maintenance operations on the target resource 1112. In one example, the one or more attributes is the resource identifier corresponding to the target resource 1112, and the hash operation generates a hash value of the resource identifier. The modulo operation may be executed on the hash value. The modulo operation may output a remainder, and the execution time for performing the system maintenance operations on the target resource 1112 may be selected based at least in part on the remainder.

As used herein, the term “modulo operation” refers to a mathematical operation that computes a remainder after division of a dividend by a divisor. A modulo operation may be represented as “A mod B,” where “A” is the dividend, and “B” is the divisor. The product of the modulo operation is the remainder obtained when “A” is divided by “B.” The remainder represents what is left over after the division of the dividend by the divisor. As an example, (15) mod (7)=(1), where dividing (15) by (7) gives a quotient of (2) and a remainder of (1). As another example, (27) mod (5)=(2), where dividing (27) by (5) gives a quotient of (5) and a remainder of (2). In one example, the remainder may be rounded to the nearest whole number. The dividend of the modulo operation may correspond to the hash value obtained by executing the hash operation on the one or more attributes corresponding to the target resource 1112 and/or the request to execute system maintenance operations on the target resource 1112. The hash operation may generate a unique, or semi-random, hash value from the one or more attributes corresponding to the target resource 1112 and/or the request to execute system maintenance operations on the target resource 1112. As a result of the unique or semi-random hash values obtained from executing the hash operation for a set of target resource 1112, the modulo operation may provide a semi-random distribution of remainder values corresponding to the set of target resources 1112. By selecting the execution times for the set of target resources 1112 based on the remainder values corresponding to the target resources 1112, the execution times may be distributed semi-randomly across the set of candidate execution times.

In one example, a modulus base of the modulo operation may correspond to a quantity of candidate execution times in the set of candidate execution times. For a candidate time period that has (34) candidate execution times, as in the example above, the modulus base of the modulo operation may be (34). As used herein, the term “modulus base” refers to the divisor “B” in the modulo operation. The modulus base represents the number by which the dividend “A” is divided. In one example, the execution time selected for executing the system maintenance operations for the target resource may correspond to a particular remainder from among the modulus base. For example, a remainder of (1) may correspond to the first candidate execution time in the set of candidate execution times, a remainder of (2) may correspond to the second candidate execution time in the set of candidate execution times, and a remainder of (0) may correspond to the thirty-fourth execution time in the set of candidate execution times.

In one example, each particular execution time for system maintenance operations may correspond to one or more remainder values from among the modulus base. In one example, each particular execution time may correspond to a particular remainder value. For example, a first execution time may correspond to a remainder value of (1), a second execution time may correspond to a remainder value of (2), and an Nth execution time may correspond to a remainder value of N, where N is the modulus base. Additionally, or alternatively, each particular execution time may correspond to a plurality of remainder values obtainable from the modulo operation. For example, a first execution time may correspond to a remainder value of from 1 to N/x, a second execution time may correspond to to a remainder value of from 1+N/x to 2 (N/x), and an Nth execution time may correspond to a remainder value of from x-1 to N, where “N” is the modulus base, and “x” is the number of candidate execution times corresponding to the candidate time period.

In one example, the schedule generation module 1116 may execute multiple hash functions and/or multiple instances of a hash function to determine an execution time. In one example, the schedule generation module 1116 may determine a first portion of the execution time by executing a first hash function and a second portion of the execution time by executing a second hash function. The schedule generation module 1116 may execute the first hash function to select a first time-value at a first time-granularity. The schedule generation module 1116 may execute the second hash function to select a second time-value at a second time-granularity. The schedule generation module 1116 may combine the first time-value corresponding to the first time-granularity with the second time-value corresponding to the second time-granularity to obtain the execution time. In one example, the first time granularity is a day of week and the second time granularity is a time of day. The schedule generation module 1116 may combine the day of the week with the time of the day to obtain an execution date and time. The schedule generation module 1116 may execute the first hash function on a first attribute. The schedule generation module 1116 may execute the second hash function on a second attribute. In one example, second attribute is an inverse of the first attribute. In one example, the first attribute is a resource identifier corresponding to the target resource 1112, and the second attribute is an inverse of the resource identifier corresponding to the target resource 1112.

In one example, the modulus base may be selected based on a desired quantity or percentage of system maintenance operations scheduled for a particular execution time. In one example, the quantity of system maintenance operations scheduled for a particular execution time may differ between respective execution times. In one example, the modulus base may be selected based at least in part on an acceptable level of variance in the quantity of system maintenance operations corresponding to respective execution times. In one example, the modulus base may be 100. In one example, the modulus base may be 1,000.

In one example, a quantity of remainder values corresponding to particular candidate execution times may be equivalent between at least some of the candidate execution times. For example, the set of candidate execution times may be spread evenly across the modulus base such that particular candidate execution times include an equivalent quantity of remainder values. Alternatively, a quantity of remainder values corresponding to a particular candidate execution time may differ between at least some of the candidate execution times. In one example, the set of candidate execution times may be spread disproportionately across the modulus base such that at least some of the candidate execution times include a different quantity of remainder values relative to one or more of the other candidate execution times. In one example, an execution time may include a first set of system maintenance operations that correspond to a first set of one or more remainder values from among the modulus base, and a second execution time may include a second set of system maintenance operations that correspond to a second set of one or more remainder values from among the modulus base. A first quantity of remainder values in the first set of one or more remainder values may differ from, and/or may be less than, a second quantity of remainder values in the second set of one or more remainder values.

In one example, remainder values may be allocated to particular candidate execution times based at least in part on a set of one or more execution time preferences. The execution time preferences may include one or more execution times that are preferred and/or one or more execution times that are unpreferred. The preferences may be determined by a cloud operator, such as a PLC operator or customer, and/or by a cloud infrastructure provider. Additional remainder values may be allocated to preferred candidate execution times to bias the hash function towards the preferred candidate execution times. Additionally, or alternatively, fewer remainder values may be allocated to unpreferred candidate execution times to bias the hash function away from the unpreferred candidate execution times.

In one example, a quantity of remainder values corresponding to particular candidate execution times may increase across a series of candidate execution times corresponding to at least a portion of a candidate time period. As a result of the increasing quantity of remainder values, the particular execution times of the series of candidate execution times may include an increasing quantity of system maintenance operations. The increasing quantity of system maintenance operations across the series of execution times may correspond to a particular system maintenance operation being executed for a set of target resources 1112. The increasing quantity of system maintenance operations across the series of execution times may reflect an increasing level of confidence in the successful performance of the particular system maintenance operation as the particular system maintenance operation is performed for an increasing number of target resources 1112. In one example, the quantity of remainder values and/or the quantity of system maintenance operations corresponding to particular execution times of the series of candidate execution times may correspond to an exponential function and/or a recursive function. An exponential function may include at least one of the following: a base exponential function (e.g., f (x)=a\hat{ }x, where “as” is a constant base greater than zero and not equal to 1), a natural exponential function (e.g., f (x)=e\hat{ }x, where “e” is the base of the natural logarithm), a logistic function, a Gompertz function, or a Weibull function. A recursive function may include a function that can be defined in terms of itself. A recursive function may include at least one of the following: a Fibonacci sequence, a factorial function, an Ackermann function, or a Collatz conjecture. In one example, a recursive function may include an exponential function, such as f (x)=a*f (x−1), where “a” is a constant base multiplied by the previous term, f (x−1).

The hash operation utilized in the hash function may include a cryptographic hash operation or a non-cryptographic hash operation. The hash operation utilized in the hash function may be selected based on one or more of the following properties: determinism, irreversibility, or avalanche effect. Determinism refers to the same input producing the same hash value. Irreversibility refers to difficulty in deriving an original input from the hash value. Avalanche effect refers to small changes in an input that results in significant changes in the hash value. An example hash operation may include a cryptographic hash operation, such as an SHA-256 hash operation, an Argon2 hash operation, a Message Digest Algorithm 5 hash operation, a RIPEMED hash operation, a Whirlpool hash operation, a Tiger hash operation, a SipHash operation, a BLAKE2 hash operation, or an SHA3 (e.g., SHA3-256) hash operation. By way of illustration, an SHA-256 or an SHA3-256 hash operation may transform an input into a 256-bit output. Additionally, or alternatively, an example hash operation may include a non-cryptographic hash operation, such as a MurmurHash hash operation, a CityHash hash operation, a Jenkins hash operation, an xxHash hash operation, a Fowler-Noll-Vo hash operation, or a CRC32 hash operation.

ii. Example Resource Allocation Module

The resource allocation module 1118 allocates maintenance resources 1108 for execution of system maintenance operations. The resource allocation module 1118 may allocate the maintenance resources 1108 based on the type and/or quantity of system maintenance operations being executed. The resource allocation module 1118 may determine the type and/or quantity of system maintenance operations from system maintenance schedules in the maintenance schedule repository 1114. Based on the type and/or quantity of system maintenance operations determined from the system maintenance schedules, the resource allocation module 1118 may allocate suitable maintenance resources 1108 for executing the system maintenance operations.

The resource allocation module 1118 may determine a set of candidate execution times from a candidate time period based at least in part on other system maintenance operations that have already been scheduled during the candidate time period. In one example, the resource allocation module 1118 determines resource constraints associated with maintenance resources 1108 that may be utilized for executing system maintenance operations. In response to determining a resource constraint, the resource allocation module 1118 may allocate additional maintenance resources 1108 for executing the system maintenance operations. Additionally, or alternatively, the resource allocation module 1118 determines underutilization of maintenance resources 1108. In response to determining an underutilization of the maintenance resources 1108, the resource allocation module 1118 may deallocate maintenance resources 1108 for executing the system maintenance operations. In one example, the resource allocation module 1118 may instruct the schedule generation module 1116 to reschedule one or more system maintenance operations by re-executing the hash function to determine a new execution time for the one or more system maintenance operations. A new execution time may be determined for one or more system maintenance operations that are scheduled for an execution time that corresponds to a resource constraint associated with one or more maintenance resources 1108. Additionally, or alternatively, a new execution time may be determined for one or more system maintenance operations that are scheduled for an execution time corresponding to an underutilization of one or more maintenance resources 1108.

The hash function may be re-executed based on an augmentation to one or more parameters of the hash function. In one example, the hash operation may be augmented for the re-execution of the hash function. Additionally, or alternatively, the modulo operation may be augmented for the re-execution of the hash function. The augmentation of the hash function may result in different execution times for one or more of the system maintenance operations that were initially scheduled for execution times corresponding to the resource constraint. The hash operation may be augmented for re-execution of the hash function by selecting a different set of one or more attributes that the hash operation is executed upon. Additionally, or alternatively, the one or more attributes may be augmented by adding a salt parameter to the one or more attributes. The salt parameter may be an additional attribute, a constant value, or a random value. Additionally, or alternatively, the augmentation to the hash operation may include selecting a different hash operation. The augmentation to the hash operation may obtain a different hash value as an input to the modulo operation. In one example, the modulo operation may be augmented for re-execution of the hash function by selecting a different modulus base. Additionally, or alternatively, one or more execution times corresponding to the resource constraint and/or one or more candidate execution times corresponding to the underutilization may be removed from the set of candidate execution times. The change to the set of candidate execution times may result in a different modulus base for the modulo operation.

In one example, the resource allocation module 1118 may determine a resource capacity for one or more maintenance resources 1108 prior to the schedule generation module 1116 generating a system maintenance schedule that utilizes the one or more maintenance resources 1108. The system maintenance schedule that utilizes the one or more maintenance resources 1108 may be based at least in part on the resource capacity determined by the resource allocation module 1118. In one example, the set of candidate execution times may be selected based at least in part on the resource capacity for the one or more maintenance resources 1108. Additionally, or alternatively, the modulus base for the modulo operation may be selected based at least in part on the resource capacity for the one or more maintenance resources 1108. Additionally, or alternatively, the number of remainder values corresponding to a one or more of the candidate execution times may be selected based at least in part on the resource capacity for the one or more maintenance resources 1108. In one example, a larger quantity of remainder values may be allocated to candidate execution times corresponding to a higher resource capacity for the one or more maintenance resources 1108. Additionally, or alternatively, a smaller quantity of remainder values may be allocated to candidate execution times corresponding to a lower resource capacity for the one or more maintenance resources 1108.

iii. Example Maintenance Initiation Module

The maintenance initiation module 1120 initiated system maintenance operations on the target resources in accordance with maintenance schedules stored in the maintenance schedule repository 1114. The maintenance initiation module 1120 may monitor the maintenance schedules for upcoming system maintenance operations and initiate the system maintenance operations at execution times corresponding to the system maintenance operations as specified in the maintenance schedules.

The system maintenance operations may include one or more of the following: proposing or deprovisioning resources, updating operating systems, updating software components, applying security updates, performing data backup operations, performing database maintenance, performing security audits, performing compliance audits, managing configuration settings, modifying auto-scaling parameters, performing disaster preparedness testing, performing troubleshooting sessions, or performing hardware upgrades.

### B. Example Operator Device Interfaces

Referring further to FIG. 11A, the virtual cloud network 1102 includes one or more operator device interfaces 1122. In one example, various partitions 1104 may include an operator device interface 1122, for example, for use by operators associated with an entity corresponding to the particular partition 1104. As shown in FIG. 11A, partition 1104a includes operator device interface 1122a, partition 1104b includes operator device interface 1122b, and partition 1104n includes operator device interface 1122n. In one example, an operator associated with a cloud infrastructure provider corresponding to partition 1104a may utilize operator device interface 1122a, for example, to interact with the maintenance scheduling tool 1106 to schedule system maintenance operations for various partitions 1104, such as for partition 1104b and/or for partition 1104n. In one example, an operator associated with a cloud operator, such as a PLC operator, corresponding to partition 1104b may utilize operator device interface 1122b, for example, to interact with the maintenance coordination module 1110a. Additionally, or alternatively, an operator associated with a cloud operator, such as a PLC operator, corresponding to partition 1104n may utilize operator device interface 1122n, for example, to interact with the maintenance coordination module 1110n. The operators may interact with the maintenance coordination modules 1110, for example, to provide candidate time periods, or time windows, for execution of maintenance operations in the corresponding partitions 1104.

In one example, the various operator device interfaces 1122 may include hardware and/or software configured to facilitate interactions between an operator and the maintenance scheduling tool 1106, a maintenance coordination module 1110, and/or other aspects of the system 1100. An operator device interface 1122 may render user interface elements and receive input via user interface elements. For example, an operator device interface 1122 may display outputs generated by the maintenance scheduling tool 1106, a maintenance coordination module 1110, and/or other aspects of the system 1100. Additionally, or alternatively, an operator device interface 1122 may be configured to receive inputs to the maintenance scheduling tool 1106, a maintenance coordination module 1110, and/or other aspects of the system 1100. Examples of interfaces include a GUI, a command line interface (CLI), a haptic interface, or a voice command interface. Examples of user interface elements include checkboxes, radio buttons, dropdown lists, list boxes, buttons, toggles, text fields, date and time selectors, command lines, sliders, pages, or forms. Any one or more of these interfaces or interface elements may be utilized by an operator device interface 1122.

In an embodiment, different components of an operator device interface 1122 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, the operator device interface 1122 may be specified in one or more other languages, such as Java, C, or C++.

In one example, the maintenance scheduling tool 1106 and/or the various maintenance coordination modules 1110 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a browser device.

### C. Example Maintenance Schedule Repository

Referring to FIG. 11B, features of an example maintenance schedule repository 1114 are further described. The maintenance schedule repository 1114 described with reference to FIG. 11B may be included in one or more embodiments described with reference to FIG. 11A. Additionally, or alternatively, one or more features of the maintenance schedule repository 1114 described with reference to FIG. 11A may be included in the maintenance schedule repository 1114 described with reference to FIG. 11B.

As shown in FIG. 11B, a maintenance schedule repository 1114 includes at least one more maintenance schedule 1150 with one or more schedule entries 1152. The one or more schedule entries 1152 include information pertaining to particular system maintenance operations. As shown in FIG. 11B, maintenance schedule 1150 includes schedule entry 1152a, schedule entry 1152b, schedule entry 1152c, schedule entry 1152d, and schedule entry 1152n. The schedule entireties 1152 respectively include an indication of a target resource 1154, a resource identifier 1156 corresponding to the target resource 1154, and a candidate time period 1158 for performing system maintenance operations corresponding to the target resource 1154. The candidate time period 1158 for a schedule entry 1152 may be determined based on an input from a maintenance coordination module 1110 (FIG. 11A) and stored in the maintenance schedule repository 1114 in the corresponding schedule entry 1152. Additionally, or alternatively, the schedule entireties 1152 may include an execution time 1160 and a maintenance operation 1162 corresponding to the target resource 1154. The execution time 1160 for a schedule entry 1152 may be determined by the schedule generation module 1116 (FIG. 11A) and stored in the maintenance schedule repository 1114 in the corresponding schedule entry 1152. The schedule generation module 1116 may determine the execution time 1160 for a schedule entry 1152 based at least in part on the candidate time period 1158 for the schedule entry 1152. The maintenance operation 1162 for a schedule entry 1152 may be determined based on a system maintenance request from an operator, for example, via an operator device interface 1122 and/or a maintenance coordination module 1110. Additionally, or alternatively, the maintenance operation 1162 for a schedule entry 1152 may be determined from a set of maintenance operations, such as a periodic, routine, or targeted set of maintenance operations that are deployed to the various target resources. In one example, the set of maintenance operations may be determined based on one or more SLAs corresponding to the various target resources. Additionally, or alternatively, the schedule entries 1152 may include a maintenance resource 1164 allocated for performing the maintenance operation 1162. The maintenance resource 1164 may be determined by the resource allocation module 1118 (FIG. 11A). The resource allocation module 1118 may determine resource constraints and/or underutilization of maintenance resources based at least in part on the maintenance resource 1164 for a schedule entry 1152.

In one or more embodiments, the maintenance schedule repository 1114 is any type of storage unit and/or device (e.g., a file system, database, collection of tables, or any other storage mechanism) for storing data. Further, the maintenance schedule repository 1114 may include multiple different storage units and/or devices. The multiple different storage units and/or devices may or may not be of the same type or located at the same physical site. Further, the maintenance schedule repository 1114 may be implemented or executed on the same computing system as the maintenance scheduling tool 1106 (FIG. 11A). Additionally, or alternatively, the maintenance schedule repository 1114 may be implemented or executed on a computing system separate from the maintenance scheduling tool 1106 (FIG. 11A). The maintenance schedule repository 1114 may be communicatively coupled to the maintenance scheduling tool 1106 (FIG. 11A) via a direct connection or via a network. Information describing the maintenance schedule repository 1114 may be implemented across any of components of the system 1100 (FIG. 11A). However, this information is described with reference to the maintenance schedule repository 1114 for purposes of clarity and explanation.

### D. Certain Definitions

As used herein, the term “resource” refers to a hardware or software component that is utilized to build, maintain, or operate a cloud infrastructure and/or services deployed in the cloud infrastructure. A hardware resource may include one or more of the following: a server, a processor, a memory device, a storage device, a networking device, a power supply device, or a cooling system device. A software resource may include one or more of the following: an operating system, a cloud management platform, a security platform, a development tool, a compute instance, a virtual machine, a container, a storage system, or a service deployed in a cloud environment. In one example, one or more services deployed in the cloud infrastructure are resources with respect to one or more other services in the cloud infrastructure.

The term “resource constraint,” as used herein with reference to a resource, refers to a limitation or restriction associated with the resource that at least partially inhibits or prevents utilization of the resource with respect at least one utilization characteristic. The utilization characteristics of a resource constraint may include one or more of the following: a utilization threshold, a physical limitation, a performance limitation, a capacity plan, an allocation policy, a cost limitation, or an efficiency parameter. A resource constraint may be represented by a percentage or a quantity. A resource constraint associated with a resource may be determined by comparing a utilization of the resource to one or more limits or restrictions for utilizing the resource with respect to one or more utilization characteristics. A resource constraint may be determined with respect to a current, scheduled, or predicted utilization. In one example, a resource has a resource constraint when the resource is currently being utilized, is scheduled to be utilized, or is predicted to be utilized in a manner that meets a limitation or restriction that at least partially inhibits or prevents utilization of the resource with respect at least one utilization characteristic. Additionally, or alternatively, a resource constraint may be determined with respect to a proposed utilization. In one example, a resource has a resource constraint when a proposed utilization, alone or together with a current, scheduled, or predicted utilization, would result in a utilization of the resource in a manner that meets a limitation or restriction that at least partially inhibits or prevents utilization of the resource with respect at least one utilization characteristic. A resource constraint may be determined with respect to finite deterministic scenarios and/or probabilistic scenarios. In one example, a resource has a resource constraint when a utilization scenario definitively meets a limitation or restriction that at least partially inhibits or prevents utilization of the resource with respect to at least one utilization characteristic. In one example, a resource has a resource constraint when a utilization scenario satisfies a probability threshold for meeting a limitation or restriction that at least partially inhibits or prevents utilization of the resource with respect at least one utilization characteristic.

As used herein, the term “service” refers to a modular, self-contained unit of functionality that is deployed in a cloud environment. A service may encapsulate a specific set of functionalities, utilities, or tasks. A service may include a unit of functionality ranging from a simple standalone application or utility to a complex distributed system that includes multiple interconnected components. A service may include a well-defined interface for interaction with other services, service features, or operator device interfaces. In one example, a service includes a compute instance, a virtual machine, a container, or a storage system. Additionally, or alternatively, a service includes an application, a program, a utility, a resource, a platform, an infrastructure as a service (IaaS), a platform as a service (PaaS), a software as a service (SaaS), a database as a service (DBaaS), a container orchestration service, a serverless computing service, a storage service, a content delivery network (CDN) service, an identity and access management (IAM) service, a networking service, a machine learning or AI service, a big data or analytics service, an internet of things (IoT) service, a blockchain service, a monitoring or logging service, a customized service, or a customer-specific service.

As used herein, the term “target resource” refers to a resource that is a target for at least a portion of one or more system maintenance operations.

As used herein, the term “maintenance resource” refers to a resource that is utilized for performing at least a portion of one or more system maintenance operations.

### 4. Example Operations for Scheduling System Maintenance

Referring to FIGS. 12A and 12B, example operations 1200 are further described in accordance with one or more embodiments. In one example, a system may execute operations 1200 pertaining to scheduling system maintenance operations in a cloud environment. One or more operations 1200 described with reference to FIGS. 12A and 12B may be modified, combined, rearranged, or omitted. Accordingly, the particular sequence of operations 1200 described with reference to FIGS. 12A and 12B should not be construed as limiting the scope of one or more embodiments. In one example, the operations 1200 may be performed by the one or more components of the system described with reference to FIG. 11.

### A. Scheduling Execution of System Maintenance Operations

Referring to FIG. 12A, a system receives a request to execute a system maintenance operation within a candidate time period (Operation 1202). The request may be initiated by a user, for example, via a maintenance coordination module. Additionally, or alternatively, the request may be initiated by a maintenance scheduling tool, for example, in response to a set of maintenance operations, such as a periodic, routine, or targeted set of maintenance operations that are deployed to the various target resources. Additionally, or alternatively, the system may determine the request for system maintenance based on one or more schedule entries in a maintenance schedule stored in a maintenance schedule repository.

In response to the request to execute the system maintenance operation, the system selects a set of candidate execution times within the candidate time period for execution of the system maintenance operation (Operation 1204). The set of candidate execution times may be included with the request. Additionally, or alternatively, the system may select the set of candidate execution times from the maintenance schedule repository.

The system executes a hash function on an attribute associated with the request to select an execution time within the set of candidate execution times (Operation 1206). The hash function may include a hash operation and a modulo operation. The hash operation may output a hash value, and the modulo operation may be executed on the hash value. The hash function may output a value that represents a remainder generated by the modulo operation. The remainder may correspond to a particular candidate execution time of the set of candidate execution times. The system may select the candidate execution time corresponding to the remainder as the execution time for the system maintenance operation. In one example, the same or identical attribute may be utilized for similar or identical maintenance operations. Executing the hash function to select execution times results in similar or identical maintenance operations being scheduled at (a) a same time of day, (b) a same day of week, (c) a same day of month, (d) a same day of year, and/or (e) a same time period. In one example, the system determines a schedule for additional executions of the system maintenance operation based at least in part on the selected execution time. In one example, the system schedules recurring execution of the system maintenance operation on a momentary, hourly, daily, weekly, monthly, and/or annual basis. The recurring executions may occur at the same time of day, the same day of week, the same day of month, the same day of year, and/or the same time period. In one example, the system determines a candidate execution time for a system maintenance operation within a time period. The time period may recur periodically or intermittently, and the system may select the candidate execution time for one or more recurrences of the time period. The system may select the candidate execution time based on an offset from a start time of a time period. The offset may correspond to a point in time within the time period. In one example, the time period includes a sixty-minute window of time that commences at 12:00 am on Wednesdays, biweekly, and the offset is 15 minutes. In one example, based at least in part on the time period and the offset, the system selects a candidate execution time of 12:15 am on Wednesdays, biweekly. Additionally, or alternatively, the system determines a schedule for execution of a set of system maintenance operations in a same category based at least in part on the selected execution time. The set of system maintenance operations in the same category may occur at the same time of day, the same day of week, the same day of month, the same day of year, and/or the same time period.

The system may determine the attribute associated with the request based on information in the maintenance schedule repository. Additionally, or alternatively, the attribute may accompany the request. In one example, the system determines the attribute associated with the request by using an API to look up the attribute based on information in a schedule entry in a system maintenance schedule corresponding to the system maintenance request. In one example, the attribute includes one or more of the following: a resource identifier corresponding to a target resource, a network address corresponding to the target resource, a label or tag assigned to the target resource, or a creation timestamp corresponding to the target resource 1112. In one example, the system determines the attribute using a DNS lookup function or a DNS look up table. Additionally, or alternatively, the system may determine the attribute based on metadata associated with the target resource and/or based on metadata associated with the request.

The system schedules the execution of the system maintenance operation at the execution time (Operation 1208). The system may schedule the execution of the system maintenance operation at least by generating or updating a schedule entry in a maintenance schedule stored in the maintenance schedule repository. The system determines whether there is an additional request to execute a system maintenance operation (Operation 1210). When the system determines that there is an additional request to execute a system maintenance operation, the system selects a set of candidate execution times within the candidate time period for execution of the system maintenance operation corresponding to the additional request (Operation 1204). When the system determines that there is not an additional request to execute a system maintenance operation, the operations 1200 conclude (Operation 1212), for example, until the system receives another request to execute a system maintenance operation (Operation 1202).

The system may receive subsequent requests to re-execute the system maintenance operation. In one example, subsequent requests to execute the system maintenance operation may occur periodically, such as monthly or weekly. Additionally, or alternatively, the subsequent requests may occur sporadically or intermittently. The requests may be associated with a particular target resource. In response to the subsequent request, the system executes the hash function on an attribute associated with the subsequent request to select an execution time from a set of candidate execution times corresponding to the subsequent request. The attribute associated with the subsequent request may be the identical attribute or a similar attribute as utilized for a previous request. Based at least on executing the hash function on the identical or similar attribute, the execution time for the subsequent request and the execution time for the previous request may correspond to (a) a same time of day, (b) a same day of week, (c) a same day of month, and/or (d) a same day of year.

Additionally, or alternatively, the system may receive additional requests to execute additional system maintenance operations that share one or more attributes with a previous system maintenance operation. In one example, the system may receive a set of system maintenance requests for a particular target resource and/or for a particular partition. The system executes the hash function on an attribute associated with the respective requests to select an execution time from a set of candidate execution times corresponding to the respective requests. The attribute associated with the respective requests may be identical or a similar attribute between the respective request. Based at least on executing the hash function on the identical or similar attribute, the execution time for the set of request may correspond to (a) a same time of day, (b) a same day of week, (c) a same day of month, and/or (d) a same day of year.

### B. Resolving Resource Constraints

Referring to FIGS. 12B, operations 1200 are further described pertaining selecting an execution time within the set of candidate execution times (Operation 1206). As shown in FIG. 12B, to select an execution time, the system determines a candidate execution time based on the hash function executed on the attribute associated with the request (Operation 1220). Upon determining the candidate execution time, the system determines whether there is a resource constraint associated with the candidate execution time (Operation 1222). When the system determines that there is a resource constraint, the system reschedules execution of the system maintenance operation at least by re-executing the hash function to select an alternative candidate execution time within the set of candidate execution times (Operation 1224). The system may re-execute the hash function at least by executing the hash operation on a different set of one or more attributes. Additionally, or alternatively, the system may re-execute the hash function at least by executing the modulo operation on a different modulus base. In one example, the system may determine a resource underutilization period coinciding with a subset of the candidate execution times exclusive of the selected execution time. The system may re-execute the hash function to select an alternative execution time from the subset of candidate execution times. Upon having re-executed the hash function and selected an alternative candidate execution time, the system determines whether there is a resource constraint associated with the alternative candidate execution time. When the system determines that there is not a resource constraint, the system selects the candidate execution time, or the alternative candidate execution time, as applicable, as the execution time (Operation 1226).

The system may determine a resource constraint associated with a system maintenance operation based on a resource utilization threshold and/or a resource allocation for one or more maintenance resources allocated for execution of the system maintenance operation. The system may compare the resource utilization threshold to the resource allocation for execution of at least one of the following: the first system maintenance operation or the second system maintenance operation. The system may determine that a resource constraint exists with respect to the one or more maintenance resources when the resource allocation meets the resource utilization threshold.

### 5. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer-readable storage media includes instructions that, when executed by one or more hardware processors, cause performance of any of the operations described herein and/or recited in any of the claims.

In an embodiment, a method includes operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
receiving a first request to execute a first system maintenance operation within a first time period;
selecting a first plurality of candidate execution times within the first time period for execution of the first system maintenance operation;
executing a hash function on a first attribute associated with the first request to select a first execution time within the first plurality of candidate execution times;
scheduling the execution of the first system maintenance operation at the first execution time;
wherein the method is performed by at least one device including a hardware processor.

2. The method of claim 1, further comprising:
receiving a second request to re-execute the first system maintenance operation within a second time period;
selecting a second plurality of candidate execution times within the second time period for re-execution of the first system maintenance operation;
executing the hash function on a second attribute associated with the second request to select a second execution time within the second plurality of candidate execution times,
wherein the first attribute and the second attribute are similar or identical, and
wherein the first execution time and the second execution time correspond to (a) a same time of day, (b) a same day of week, (c) a same day of month, and/or (d) a same day of year;
scheduling the re-execution of the first system maintenance operation at the second execution time.

3. The method of claim 1, further comprising:
receiving a second request to execute a second system maintenance operation within a second time period, wherein the second system maintenance operation shares one or more attributes with the first system maintenance operation;
selecting a second plurality of candidate execution times within the second time period for execution of the second system maintenance operation;
executing the hash function on a second attribute associated with the second request to select a second execution time within the second plurality of candidate execution times,
wherein the first attribute and the second attribute are similar or identical, and
wherein the first execution time and the second execution time correspond to at least one of: (a) a same time of day, (b) a same day of week, (c) a same day of month, (d) a same day of year, or (e) a same time period;
scheduling the execution of the second system maintenance operation at the second execution time.

4. The method of claim 1, wherein executing the hash function to select execution times results in similar or identical maintenance operations being scheduled at (a) a same time of day, (b) a same day of week, (c) a same day of month, (d) a same day of year, and/or (e) a same time period.

5. The method of claim 1, wherein the first plurality of candidate execution times is selected within the first time period based at least in part on other system maintenance operations that have already been scheduled during the first time period.

6. The method of claim 1, further comprising:
based at least in part on the first execution time: determining a schedule for (a) additional executions of the first system maintenance operation, or (b) executions of other system maintenance operations in a same category as the first system maintenance operation.

7. The method of claim 1, wherein the first attribute comprises an identifier associated with the first request.

8. The method of claim 1, wherein the first time period comprises a user-specified time period.

9. The method of claim 8, wherein selecting the first plurality of candidate execution times comprises:
determining a plurality of available execution times within the first time period;
selecting the plurality of available execution times as the first plurality of candidate execution times.

10. The method of claim 1, further comprising:
receiving a second request to execute a second system maintenance operation within a second time period;
selecting a second plurality of candidate execution times within the second time period for execution of the second system maintenance operation;
executing the hash function on a second attribute associated with the second request to select a second execution time within the second plurality of candidate execution times;
determining a resource constraint between execution of the first system maintenance operation at the first execution time and execution of the second system maintenance operation at the second execution time;
responsive to determining the resource constraint: executing the hash function on a third attribute associated with the second request to select a third execution time within the second plurality of candidate execution times;
scheduling the execution of the second system maintenance operation at the third execution time.

11. The method of claim 10, wherein the third attribute comprises a combination of the second attribute and a salt parameter.

12. The method of claim 10, further comprising:
responsive to determining the resource constraint:
executing the hash function on a fourth attribute associated with the first request to select a fourth execution time within the first plurality of candidate execution times;
rescheduling the execution of the first system maintenance operation from the first execution time to the fourth execution time.

13. The method of claim 10, wherein the resource constraint comprises a resource constraint associated with the execution of at least one of: the first system maintenance operation, or the second system maintenance operation.

14. The method of claim 10, further comprising:
comparing a resource utilization threshold to a resource allocation for execution of at least one of: the first system maintenance operation, or the second system maintenance operation;
determining that the resource allocation meets the resource utilization threshold;
determining the resource constraint based on the resource allocation meeting the resource utilization threshold.

15. The method of claim 1, further comprising:
receiving a second request to execute a second system maintenance operation within a second time period;
selecting a second plurality of candidate execution times within the second time period for execution of the second system maintenance operation;
executing the hash function on a second attribute associated with the second request to select a second execution time within the second plurality of candidate execution times;
determining a resource constraint between execution of the first system maintenance operation at the first execution time and execution of the second system maintenance operation at the second execution time;
responsive to determining the resource constraint:
scheduling the execution of the second system maintenance operation at the second execution time;
scheduling additional resources for at least one of: execution of the first system maintenance operation at the first execution time, or execution of the second system maintenance operation at the second execution time.

16. The method of claim 1, further comprising:
determining a resource underutilization period coinciding with at least a portion of the first plurality of candidate execution times exclusive of the first execution time;
responsive to determining the resource underutilization period:
executing the hash function on a second attribute associated with the first request to select a second execution time coinciding with the resource underutilization period;
rescheduling the execution of the first system maintenance operation from the first execution time to the second execution time.

17. The method of claim 1, wherein executing the hash function on the first attribute associated with the first request to select the first execution time within the first plurality of candidate execution times comprises:
executing a first hash function on the first attribute to select a first time-value at a first time-granularity;
executing a second hash function on a second attribute associated with the first request to select a second time-value at a second time-granularity;
determining the first execution time at least by combining the first time-value with the second time-value.

18. The method of claim 17, wherein the first time-granularity comprises a date, wherein the second time-granularity comprises a time, and wherein the first execution time comprises the date and the time.

19. One or more non-transitory computer-readable media storing instructions that, when executed by one or more hardware processors, cause performance of operations comprising:
receiving a first request to execute a first system maintenance operation within a first time period;
selecting a first plurality of candidate execution times within the first time period for execution of the first system maintenance operation;
executing a hash function on a first attribute associated with the first request to select a first execution time within the first plurality of candidate execution times;
scheduling the execution of the first system maintenance operation at the first execution time.

20. A system comprising:
at least one device including a hardware processor;
the system being configured to perform operations comprising:
receiving a first request to execute a first system maintenance operation within a first time period;
selecting a first plurality of candidate execution times within the first time period for execution of the first system maintenance operation;
executing a hash function on a first attribute associated with the first request to select a first execution time within the first plurality of candidate execution times;
scheduling the execution of the first system maintenance operation at the first execution time.
